(19) United States
(12) Patent Application Publication
(10) Pub. No.: US 2010/0229205 A1
(43) Pub. Date: Sep. 9, 2010

(54) Cellular Television Broadcast System

(75) Inventor: Shigeaki Hakusui, Boxford, MA (US)

Correspondence Address: Sunstein Kann Murphy & Timbers LLP, 125 SUMMER STREET, BOSTON, MA, 02110-1618, US

(73) Assignee: CELLULAR TERRESTRIAL BROADCASTING, LLC, Haymarket, VA (US)

(21) Appl. No.: 12/722,844

(22) Filed: Mar. 12, 2010

Related U.S. Application Data
(63) Continuation-in-part of application No. 11/442,661, filed on May 26, 2006.
(60) Provisional application No. 60/685,242, filed on May 27, 2005.
(60) Provisional application No. 60/786,130, filed on Mar. 27, 2006.
(60) Provisional application No. 61/159,974, filed on Mar. 13, 2009.
(60) Provisional application No. 61/169,567, filed on Apr. 15, 2009.

(51) Int. Cl. H04N 7/16; H04N 7/173; H04W 4/00

(52) U.S. Cl. 725/62; 725/115; 725/118; 370/328

(57) ABSTRACT

Information services are provided via an over-the-air television broadcasting system that is segmented into a plurality of cells. Each cell includes one or more transmitting facilities. The transmitting facilities of adjacent cells may operate on the same television channel and/or on different television channels, typically chosen from a frequency set allocated to a given service provider. The service information may include different content in different cells, such as local content specific to each cell. Content may be provided from one or more content providers in communication with the transmitting facilities.

### CROSS-REFERENCE TO RELATED APPLICATIONS

This patent application is a continuation-in-part of U.S. patent application Ser. No. 11/442,661 entitled CELLULAR TELEVISION BROADCAST SYSTEM filed on May 26, 2006 in the names of Shigeaki Hakusui and Takeo Kanai (Attorney Docket No. 2747/109), which claims the benefit of U.S. Provisional Patent Application No. 60/685,242 entitled CELLULARIZED OVER-THE-AIR MULTIMEDIA BROADCAST SYSTEM filed on May 27, 2005 in the names of Shigeaki Hakusui and Takeo Kanai (Attorney Docket No. 2747/105) and the benefit of U.S. Provisional Patent Application No. 60/786,130 entitled CELLULAR TELEVISION BROADCAST SYSTEM filed on Mar. 27, 2006 in the names of Shigeaki Hakusui and Takeo Kanai (Attorney Docket No. 2747/107).

This patent application also claims the benefit of U.S. Provisional Patent Application No. 61/159,974 entitled CELLULAR TELEVISION BROADCAST SYSTEM filed on Mar. 13, 2009 in the name of Shigeaki Hakusui (Attorney Docket No. 2747/112) and the benefit of U.S. Provisional Patent Application No. 61/169,567 entitled CELLULAR TELEVISION BROADCAST SYSTEM filed on Apr. 15, 2009 in the name of Shigeaki Hakusui (Attorney Docket No. 2747/113).

Each of the above-referenced patent applications is incorporated herein by reference in its entirety.

### FIELD OF THE INVENTION

The present invention relates to delivery of information services, specifically using a cellular over-the-air broadcast television system.

### BACKGROUND

Current over-the-air TV broadcast systems use a single frequency band for a given service operator or a TV program. Therefore, a program recipient selects a TV program or a particular service operator by selecting the particular frequency (referred to hereinafter as a television channel) for the program or operator. This remains true when it comes to digital TV broadcast.

The aforementioned scheme, however, limits the available data (such as digital TV programs) that may be transmitted since the available bandwidth for all the recipients is limited to the bandwidth at which the operator operates. In the NTSC Standard, for example, the bandwidth is 6 MHz. Some television operators, however, have a plurality of frequency bands in case interference is severe and an auxiliary band is needed to overcome the interference. Regardless of the number of frequency bands a certain broadcaster has, broadcasters try reduce the number of transmitters and maximize the coverage area for economical reasons (e.g., high-power transmitting equipment is typically very expensive to own and operate, and a large coverage area attracts large advertisers from which the broadcasters derive significant revenue). Because of the limited bandwidth and single, large coverage area of traditional over-the-air TV broadcasting, over-the-air TV broadcasting is not particularly well suited to high-bandwidth applications (e.g., video-on-demand), and is limited in its ability to deliver location based contents to specific areas.

### SUMMARY OF THE INVENTION

Embodiments of the present invention provide information services via an over-the-air television broadcasting system that is segmented into a plurality of cells. Each cell typically includes one or more transmitting facilities. The transmitting facilities of adjacent cells may operate on the same television channel and/or on different television channels, typically chosen from a frequency set allocated to a given service provider. The coverage areas of different cells can have different effective sizes and shapes depending on, among other things, the placement and power of transmitters.

In accordance with one aspect of the invention there is provided a cellular television broadcasting system comprising a first transmission station including a first location-based service router and a first plurality of television transmitters in communication with the location-based service router. Each television transmitter is configured to transmit content received from the location-based service router over at least one designated over-the-air broadcast television channel. The location-based service router is configured to distribute common content to all of the first plurality of television transmitters and to selectively distribute different local content to different subsets of such television transmitters. Each television transmitter is configured to transmit the common content and any local content received from the location-based service router over its at least one designated over-the-air broadcast television channel. The location-based service router may be configured to add advertisements to at least one of the common content and the local content.

In various alternative embodiments, one or more television transmitters (and typically all of the television transmitters) are configured to multiplex the common content and the local content into a single transport stream of a digital television signal transmitted by the television transmitter. The common content may be required (e.g., by FCC regulations) to be transmitted on a specific subchannel of the transport stream, such as the first subchannel, with other content transmitted on other subchannels. Each television transmitter may be configured to transmit mapping information including channel and subchannel information associated with multiplexed content. The common content may include digital television programming required by an FCC license to be broadcast within a coverage area of at least one of the television transmitters.

In further embodiments, one or more of the television transmitters may be configured to transmit a beacon signal including channel availability information. The channel availability information may include information regarding television channels that are in-use, information regarding television channels that must be avoided, information regarding television channels that are available for use by other transmitters, and/or information regarding return channels for user-to-system communications. The channel availability information may be based on topology information, third party whitespace information, and/or reception measurements.

In still further embodiments, the system may include one or more content sources in communication with the location-based service router. Content sources may include such things as a content server configured to store content, a production server configured to automatically generate content based on information obtained from at least one third party information source, a content creation web server configured to automatically generate content based on user-specified content and distribution information, a premium content server configured to provide content relating to premium content services, a unified call connector server configured to provide content relating to messaging and other communication services, an interactive server configured to provide content relating to interactive Internet access services, a media exchange system configured to store user content for use by other users, and/or a peer-to-peer content distribution network. The system may include one or more receivers configured to receive user-to-system communications over a designated return channel for such things as an interactive service associated at least one content source and/or collecting usage information. Such receivers may communicate wirelessly over television channel frequencies or other frequencies and/or may communicate over other communication media.

In still further embodiments, the system may include multiple transmission stations, each including a location-based service router and a plurality of television transmitters. In such embodiments, two or more of the location-based service routers may be in communication with a common content source.

In certain embodiments, a peer-to-peer content distribution network may be included to distribute content to a plurality of peer nodes. The peer-to-peer network may operate as a hierarchy of nodes including at least one set of nodes, the nodes in the set managed by a hierarchically higher managing node that manages peer-to-peer communications for the nodes, such that one or more nodes are managed by a managing node and one or more managing nodes may be managed by a hierarchically higher managing node. The nodes in the peer-to-peer network may communicate using aliases so as to be independent of underlying node addresses. Each managing node may be configured to permit peer-to-peer communication between the nodes it manages and to permit peer-to-peer communication between a node it manages and a node managed by another managing node. Peer-to-peer communication between the nodes managed by the managing node may be permitted free of charge while peer-to-peer communication between a node managed by the managing node and a node managed by another managing node may be permitted for a charge. Each managing node may be configured to perform security and administrative functions for the nodes it manages. One or more user devices (e.g., broadband routers) may be configured to operate in the peer-to-peer network. Content may be stored in multiple locations within the peer-to-peer network for at least one of backup and load sharing.

In certain embodiments, a media exchange system may be included to store user content for use by other users. Tags may be used to identify user content as being available and/or to track usage of the content.

### BRIEF DESCRIPTION OF THE DRAWINGS

The foregoing features of the invention will be more readily understood by reference to the following detailed description, taken with reference to the accompanying drawings, in which:

FIG. 1 is a schematic diagram showing a representation of the coverage area of a television system operating with a single television channel as known in the art;

FIG. 2 is a schematic diagram showing a representation of the coverage area of a cellular television system in accordance with an exemplary embodiment of the present invention;

FIG. 3 is a schematic diagram showing a representation of a cellular television system in which adjacent cells utilize different television channels, in accordance with an exemplary embodiment of the present invention;

FIG. 4 is a schematic diagram showing a representation of a cellular television system using a second television channel in one cell, in accordance with an exemplary embodiment of the present invention;

FIG. 5 is a schematic diagram showing a representation of a cellular television system using a second television channel in two adjacent cells, in accordance with an exemplary embodiment of the present invention;

FIG. 6 is a schematic diagram showing a representation of a cellular television system using a separate television channel overlaying the entire coverage area, in accordance with an exemplary embodiment of the present invention;

FIG. 7 is a schematic diagram showing a representation of a cellular television system utilizing three television channels in order to prevent interference among adjacent cells, in accordance with an exemplary embodiment of the present invention;

FIG. 8 is a schematic diagram showing a representation of a cellular television system having different size cells, in accordance with an exemplary embodiment of the present invention;

FIG. 9 is a schematic diagram showing a representation of a cellular television system including geographically defined cells, in accordance with an exemplary embodiment of the present invention;

FIG. 10 is a schematic diagram showing a representation of a cellular television system 100 capable of delivering specific programming to different cells, in accordance with an exemplary embodiment of the present invention;

FIG. 11 is a schematic diagram showing a representation of a system having a global content server and a plurality of local content servers, in accordance with an exemplary embodiment of the present invention;

FIG. 12 is a schematic diagram showing a representation of segmented transmissions, in accordance with an exemplary embodiment of the present invention;

FIG. 13 shows a sequence of transmission segments in accordance with an exemplary embodiment of the present invention;

FIG. 14 is a schematic diagram showing a representation of a cellular television system in which IP packets containing multimedia contents are transmitted to the end-user over the air, in accordance with an exemplary embodiment of the present invention;

FIG. 15 is a schematic diagram showing a representation of a cellular television system with various types of upstream communications, in accordance with an exemplary embodiment of the present invention;

FIG. 16 is a schematic diagram showing a representation of a cellular television system with cellular upstream communications, in accordance with an exemplary embodiment of the present invention;

FIG. 17 is a schematic diagram showing a representation of a cellular television system for mobile communications such as navigation, in accordance with an exemplary embodiment of the present invention;

FIG. 18 is a schematic diagram showing a representation of a cellular television system including upstream communications over an auxiliary IP connection, in accordance with an exemplary embodiment of the present invention;

FIG. 19 is a schematic diagram showing some potential equipment configurations at service provider headend, in accordance with an exemplary embodiment of the present invention;

FIG. 20 is a schematic diagram showing a representation of an asymmetric server, in accordance with an embodiment of the present invention;

FIG. 21 is a schematic diagram showing the relevant components of a receiver unit having a single television tuner, in accordance with an exemplary embodiment of the present invention;

FIG. 22 is a schematic diagram showing the relevant components of a receiver unit having two television tuners, in accordance with an exemplary embodiment of the present invention;

FIG. 23 is a conceptual block diagram showing the relevant components of a receiver unit including upstream communication support, in accordance with an exemplary embodiment of the present invention;

FIG. 24 shows a representation of the layer model for the ISBD-T protocol as known in the art;

FIG. 25 shows a representation of the layer model for a cellular broadcasting protocol in accordance with an exemplary embodiment of the present invention;

FIG. 26 is a logic flow diagram describing method for providing information services in a cellular television system, in accordance with an exemplary embodiment of the present invention;

FIG. 27 is a schematic diagram showing a representation of mapping information transmitted in a cellular television system, in accordance with an exemplary embodiment of the present invention;

FIG. 28 is a schematic diagram showing a representation of channel analysis vectors, in accordance with an exemplary embodiment of the present invention;

FIG. 29 is a schematic diagram showing a representation travel direction estimation, in accordance with an exemplary embodiment of the present invention;

FIG. 30 is a schematic diagram showing a representation of roaming, in accordance with an exemplary embodiment of the present invention;

FIG. 31 is a schematic diagram showing a network configuration in accordance with an exemplary embodiment of the present invention; and

FIG. 32 is a schematic diagram showing the relevant components of a transmission system in accordance with an exemplary embodiment of the present invention.

### DETAILED DESCRIPTION OF SPECIFIC EMBODIMENTS

Definitions. As used in this description and the accompanying claims, the following terms shall have the meanings indicated, unless the context otherwise requires:

A “mobile receiver unit” is a receiver unit that is capable of moving or being moved among cells of a cellular television system. For example, a mobile receiver unit may be portable or may be installed in a vehicle such as an automobile, motorcycle, boat, etc.

“Mapping information” is information that is transmitted in each cell of a cellular television system in order to enable remote mobile receiver units to operate effectively in a cellular television system. The mapping information typically includes adjacent cell information enabling mobile receiver units to transition between cells without requiring a return communication path from the receiver units to the service provider and without requiring a complex hand-off, as is typically required in cellular telephone systems. The mapping information may also include information about the current cell (such as information regarding topology, power, coverage, CTR location, offset, shape, utilization) as well as information regarding the service information (such as contents identifiers and stream identifiers).

In embodiments of the present invention, information services are provided via an over-the-air television broadcasting system that is segmented into a plurality of cells. Each cell typically includes one or more transmitting facilities. The transmitting facilities of adjacent cells may operate on the same television channel and/or on different television channels, typically chosen from a frequency set allocated to a given service provider. The coverage areas of different cells can have different effective sizes and shapes depending on, among other things, the placement and power of transmitters.

Within a cell, information may be broadcast, multicast, and/or unicast to one or more users. Embodiments of the present invention can operate over virtually any television channel(s), although specific embodiments may utilize vacant UHF television channels within a given service area. Although some UHF television channels are still used for traditional (NTSC) television broadcasts and others are now being used for HDTV broadcasts and even wireless microphones for local sporting events, there are generally many vacant UHF television channels in any given service area. Since the UHF television channels are already allocated by the FCC, it is anticipated that UHF-based cellular television systems could be established quickly and with little, if any, FCC approval processes.

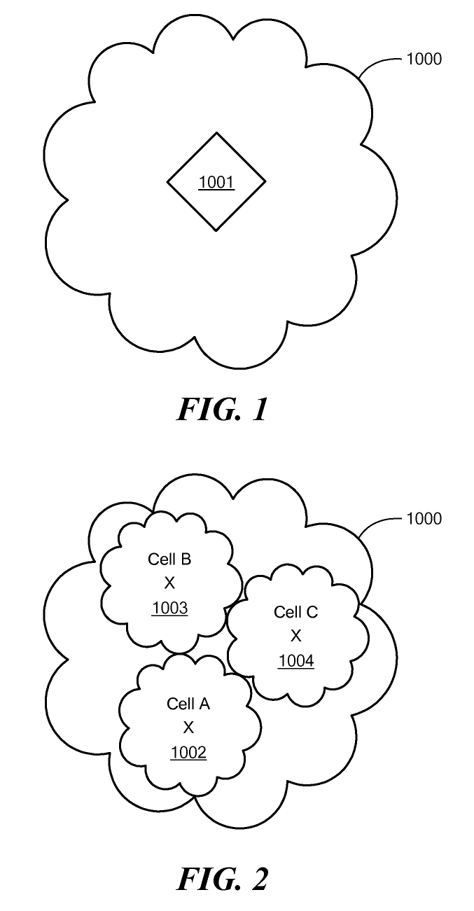

FIG. 1 is a schematic diagram showing a representation of the coverage area of a television system operating with a single television channel as known in the art. The transmitting facility 1001 operates on a designated television channel at a designated power level, and has an effective coverage area 1000 within which receiver units (such as television sets) can receive a particular program or service.

FIG. 2 is a schematic diagram showing a representation of the coverage area of a cellular television system in accordance with an exemplary embodiment of the present invention. In this example, the cellular television system includes three cells, namely Cell A 1002, Cell B 1003, and Cell C 1004. The cells can be arranged or otherwise configured to have an effective coverage area substantially equal to an existing single-channel broadcast television system 1000 (e.g., an existing television broadcaster having a license to operate within a specified coverage area might convert to a cellular television system that is constrained to operate within that coverage area), or the cells can be arranged or otherwise configured in any way permitted by available airspace.

Segmenting the coverage area into a plurality of cells effectively increases the traffic capacity of the system. For example, a system operating with a single NTSC television channel has an aggregate bandwidth of 6 MHz, whereas a cellular system having N cells (with a single television channel each) has an aggregate bandwidth of N×6 MHz. Furthermore, the system is readily expandable/scalable, for example, by adding more transmitters to meet additional bandwidth requirements. Additional advantages can be realized with such a cellular system, including the use of lower power transmitters, which are generally less expensive to own and operate and which generally cause less electromagnetic interference compared to high-power transmitters.

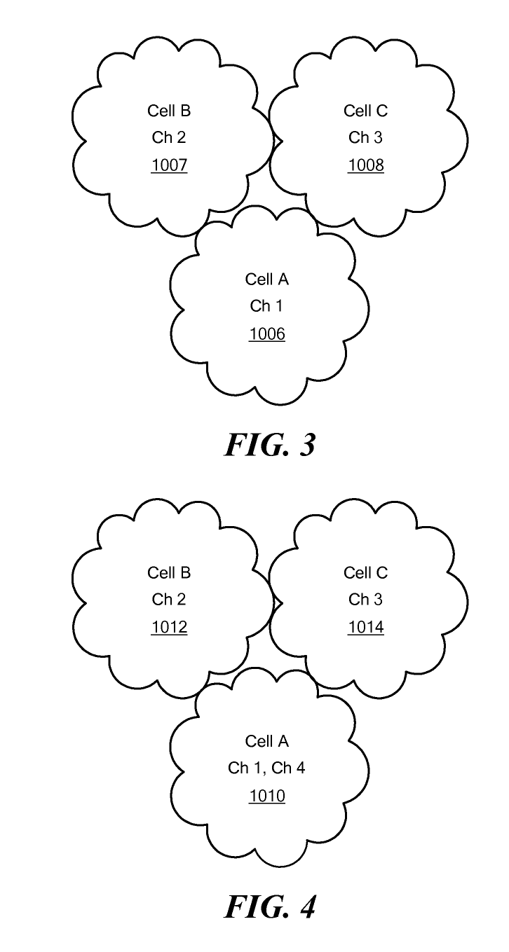

Television channels can be assigned to cells in a variety of ways, and the present invention is not limited to any particular channel assignment scheme. FIG. 3 is a schematic diagram showing a representation of a cellular television system in which adjacent cells utilize different television channels, in accordance with an exemplary embodiment of the present invention. In this example, the cellular television system includes three cells, namely Cell A 1006, Cell B 1007, and Cell C 1008. Cell A 1006 is configured to operate on a first distinct television channel (Ch1), Cell B 1007 is configured to operate on a second distinct television channel (Ch2), and Cell C 1008 is configured to operate on a third distinct television channel (Ch3).

Although additional bandwidth can be provided by adding transmitting facilities, additional bandwidth can also be provided using multiple television channels in one or more cells. For example, a second television channel may be assigned to a single cell or to multiple cells, or a separate television channel may overlay a region or the entire coverage area. Additional television channels may be allocated statically or dynamically to meet bandwidth/service requirements.

Thus, service information may be delivered to the receiver units via multiple television channels. In some cases, duplicate information may be carried over different television channels. A segment identifier or other mechanism may be used to facilitate detection of duplicate information. For example, if duplicate MPEG2-TS data is transmitted over multiple television channels, the packet identifiers of MPEG2 packets received over different television channels may be compared to detect duplicate information.

The following describes several methods by which the frequencies may be allocated and assumes that four television channels (Ch1, Ch2, Ch3, Ch4) are available to the system.

FIG. 4 is a schematic diagram showing a representation of a cellular television system using a second television channel in one cell, in accordance with an exemplary embodiment of the present invention. In this example, the cellular television system includes three cells, namely Cell A 1010, Cell B 1012, and Cell C 1014. Cell A 1010 is configured to operate on television channels Ch1 and Ch4, Cell B 1012 is configured to operate on television channel Ch2, and Cell C 1014 is configured to operate on television channel Ch3.

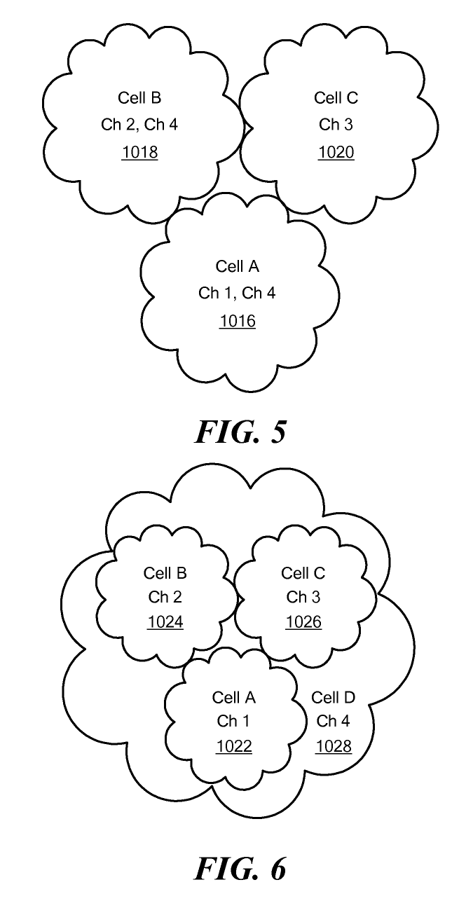

FIG. 5 is a schematic diagram showing a representation of a cellular television system using a second television channel in two adjacent cells, in accordance with an exemplary embodiment of the present invention. In this example, the cellular television system includes three cells, namely Cell A 1016, Cell B 1018, and Cell C 1020. Cell A 1016 is configured to operate on television channels Ch1 and Ch4, Cell B 1018 is configured to operate on television channels Ch2 and Ch4, and Cell C 1020 is configured to operate on television channel Ch3. In some embodiments, Ch4 may be assigned to another group of cells as long as interference to Cell1 and Cell2 is negligible. Ch4 can be assigned to all the cells if some contents are broadcasted to all the end-users in the system.

FIG. 6 is a schematic diagram showing a representation of a cellular television system using a separate television channel overlaying the entire coverage area, in accordance with an exemplary embodiment of the present invention. In this example, the cellular television system includes four cells, namely Cell A 1022, Cell B 1024, and Cell C 1026, and Cell D 1028. Cell A 1022 is configured to operate on television channel Ch1, Cell B 1024 is configured to operate on television channel Ch2, Cell C 1026 is configured to operate on television channel Ch3, and Cell D 1028 is configured to operate on television channel Ch4 in such a way that the coverage area of Cell D 1028 overlays the coverage areas of Cells A, B, and C.

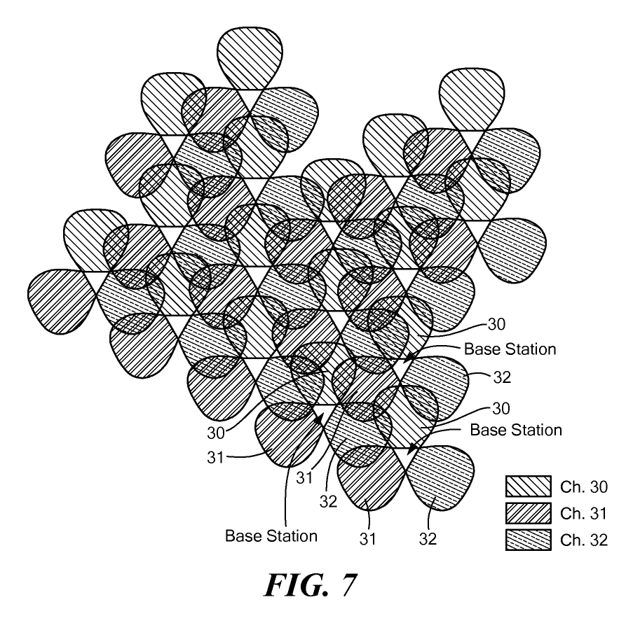

FIG. 7 is a schematic diagram showing a representation of a cellular television system utilizing three television channels in order to prevent overlap between adjacent cells, in accordance with an exemplary embodiment of the present invention. In this example, each base station includes three transmitting facilities forming three cells operating on three distinct channels, namely Ch30, Ch31, and Ch32. The cells are arranged so that no two adjacent cells operate on the same channel.

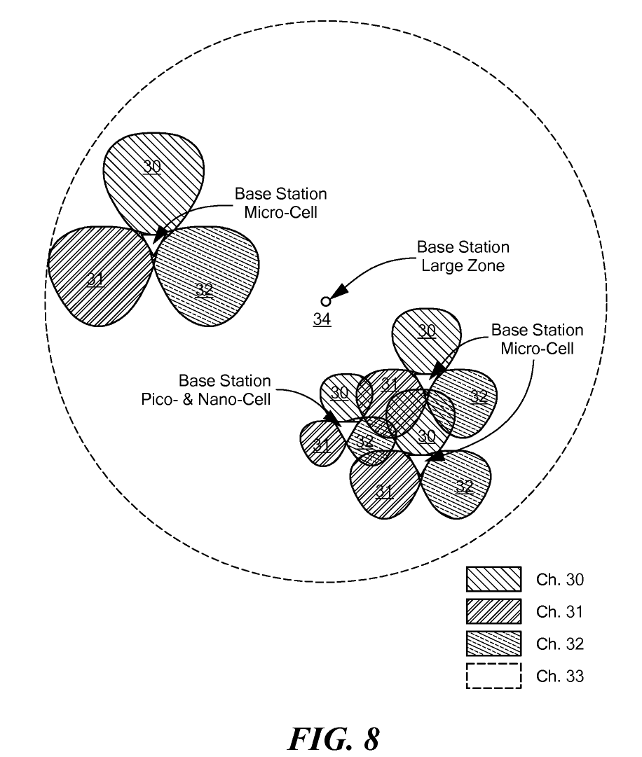

FIG. 8 is a schematic diagram showing a representation of a cellular television system having different size cells, in accordance with an exemplary embodiment of the present invention. In this example, the system includes a large cell and a number of smaller cells designated as micro-cells, pico-cells, and nano-cells to imply the relative sizes of the smaller cells. The base stations of each of the smaller cells include three transmitting facilities forming three cells operating on three distinct channels, namely Ch30, Ch31, and Ch32. The cells are arranged so that no two adjacent cells operate on the same channel. The base station of the large zone includes a transmitting facility forming a large cell operating on a distinct fourth channel, namely Ch33. The coverage area of the large cell encompasses the coverage areas of the smaller cells.

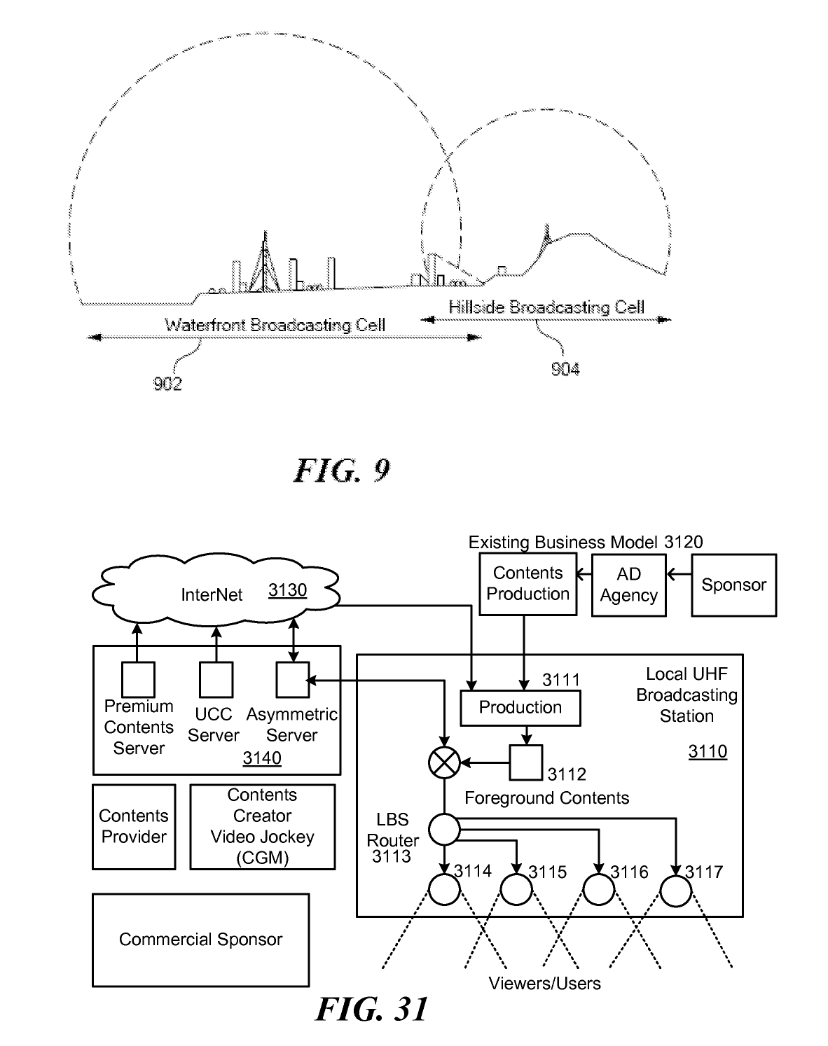

FIG. 9 is a schematic diagram showing a representation of a cellular television system including geographically defined cells, in accordance with an exemplary embodiment of the present invention. In this example, the system includes a waterfront broadcasting cell 902 and a hillside broadcasting cell 904. Such segmentation by geography may be useful, for example, in providing relevant localized information for each type of geographical region. For example, local information such as tide schedules, flood warnings, and shark sightings may be transmitted in the waterfront broadcasting cell 902, where such information may not be particularly useful for users located in the hillside broadcasting cell 904. If a particular user is traveling, say, from a home in the hillside region to a beach in the waterfront region, the user would be able to receive the waterfront information upon entering the waterfront broadcasting cell 902.

It should be noted that adjacent cells can operate on the same television channel(s). In such embodiments, interference between adjacent cells can be reduced or eliminated by transmitting each channel differently so as to form geographically different cell boundaries among different channels. For example, assuming that three adjacent cells operate on the same television channels Ch1, Ch2, and Ch3, each channel can be transmitted differently in each cell (e.g., by placement/orientation of transmitter) in order to tailor the coverage area of each television channel so as to reduce or eliminate interference.

Specific embodiments of the present invention are designed to permit one-way broadcast operation (i.e., from the service provider to the users), although optional return paths (i.e., from the users to the service provider) can be supported, for example, to provide enhanced services, such as interactive and on-demand services. In order to permit one-way broadcast operation, each cell typically broadcasts, among other things, mapping information including at least adjacent cell information enabling mobile receiver units to transition between cells without requiring a return communication path from the receiver units to the service provider and without requiring a complex hand-off, as is typically required in cellular telephone systems. The mapping information may also include information about the current cell (such as information regarding topology, power, coverage, CTR location, offset, shape, utilization) as well as information regarding the service information (such as contents identifiers and stream identifiers).

The cells generally operate independently of one another and therefore can optionally convey different content in different cells (e.g., including local and regional content), although operation of the cells is generally coordinated in order to provide a particular information service across multiple cells (i.e., a user can generally continue to receive the same service when moving from cell to cell). Thus, the system typically includes one or more content servers in communication with the transmitting facilities. A single content server can provide information for multiple cells (including local content for each of a number of cells), or separate content servers can be used to provide some or all of the content for individual cells. Some examples of local content include local traffic information, local weather information, local navigation information, local news, information about local businesses and attractions, and coupons/advertisements for local businesses and attractions, to name but a few. Regional content may include similar types of information relating to a region or a number of cells. Global content may include similar types of information relating to the entire coverage area, and may be used particularly to provide information that is relevant to all users in the coverage area (e.g., emergency notifications and information, world/national news, alerts such as so-called “Amber” alerts, and all-point bulletins, to name but a few). The characterization of any particular type of content as local, regional, or global is arbitrary and may be different for different service providers. Some exemplary information services are discussed below.

As discussed above, information may be unicast to individual users. In other words, the representation of the program contents (e.g., station channel or TV program) may appear the same to the user while the receiver roams from cell to cell. Therefore, each receiver unit may be associated with an address (such as an IP address) that is typically unique within the system. Addresses may be assigned statically or dynamically. The service provider may maintain a distribution table or other mechanism for mapping particular services or content to specific users or groups of users (including services or content to be broadcast to all users) and/or to specific cells. The distribution table may include additional information such as, for example, time of broadcast, end user location, broadcast frequency band, and the like.

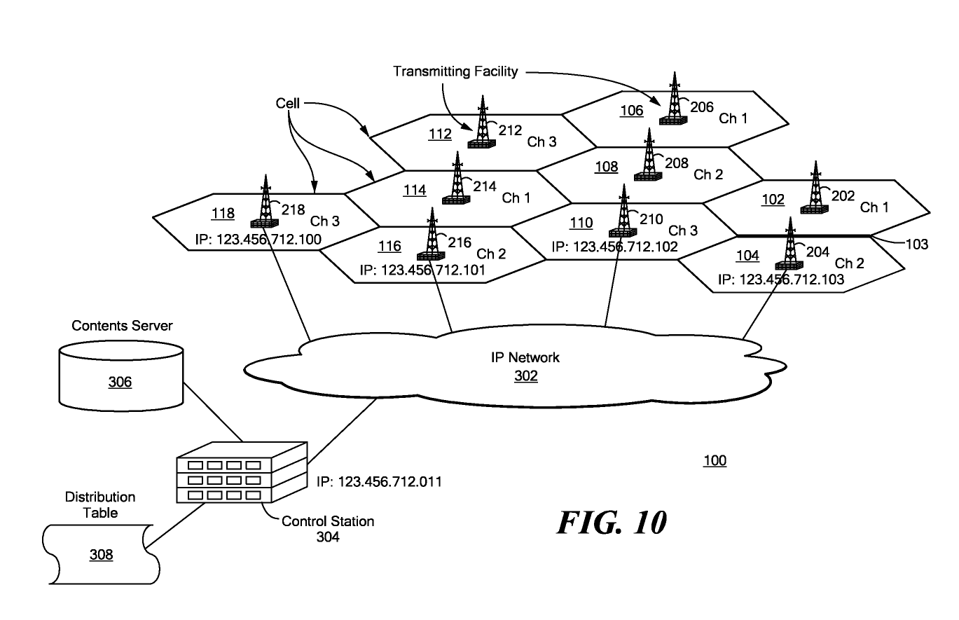

FIG. 10 is a schematic diagram showing a representation of a cellular television system 100 capable of delivering specific programming to different cells, in accordance with an exemplary embodiment of the present invention. The system 100 includes a plurality of cells 102, 104, 106, 108, 110, 112, 114, 116, and 118. Each cell typically includes a transmitting facility, although this is not required. The transmitting facility in each cell is shown as a tower and has a reference numeral that that corresponds to the cell in which it is located except that the reference numeral begins with a 2 rather than a 1. That is, for example, the transmitting facility in cell 102 has reference numeral 202, the transmitting facility in cell 104 has reference numeral 204, etc.

In FIG. 10, each cell is represented by a hexagonal coverage area. Thus, each cell may be surrounded by up to six other cells. In certain embodiments of the present invention, no adjacent cells include transmitting facilities which operate on the same television channel. Thus, for example, if a particular cell operates on television channel Ch1, then no adjacent cell would operate on television channel Ch1.

The segmentation shown in FIG. 10 may allow, for example, the service provider to broadcast localized contents to an intended area. Since the traffic is kept locally, such application further increases the frequency efficiency. Examples of local traffic are advertisement from local stores and community announcements, etc. The geographical definition of the locality is flexible and editable since a subset of cells describes the locality.

In FIG. 10, for example, identical contents may be broadcasted to only two cells, e.g., 104 and 110 by selecting the transmitting facilities 204 and 210, respectively, associated with those particular cells. Each of the transmitting facilities is typically capable of transmitting multimedia content to end-users located within a cell. In some embodiments, the content is television.

In some embodiments of the present invention, the transmitting facility associated with each cell may be given a unique internet protocol (IP) address. For example, and as shown in FIG. 10, transmitting station 218 may be assigned IP address 123.456.712.100, transmitting station 216 may be assigned IP address transmitting 123.456.712.101, transmitting station 210 may be assigned IP address 123.456.712.102, and transmitting station 218 may be assigned IP address 123.456.712.103. In embodiments where each (or at least more than one) transmitting facility is assigned an IP address, some or all of the transmitting facilities may be connected to an IP network 302.

In addition to the various cellular television system components described above, a cellular television system, such as the system shown in FIG. 10, may include additional components, such as, for example, a control station 304, a contents server 306, and an IP network 302. In some embodiments, the IP network may be the Internet or any other public or private network. The IP network may operate as an OSI Layer-3 Network layer.

In the embodiment of FIG. 10, the control station 304 is the control center for the entire cellular television system and may include the contents server 306 and the distribution table 308. The contents server 306 may be any server capable of distributing contents to an appropriate transmitting facility. In some embodiments, the contents server 306 may be any server that may access the Internet. In some embodiments, the contents server 306 may also have access to a distribution table 308. The distribution table 308 may be used to determine which users or cells have selected (or have been assigned) specific content or service. As discussed above, the distribution table 308 may include additional information such as, for example, time of broadcast, end user location, broadcast frequency band, and the like.

It should be understood that the contents server 306 may or may not be located in the control station 304 and may actually be controlled by another service operator. Typically, as long as there is a business agreement, and appropriate supervision, contents from any number of service operators can be broadcasted directly from one operator's server.

In some embodiments of the present invention, the system may also include monitoring receivers. These monitoring receivers may be located at a transmitting facility or at a possible cell edge (for example, the edge between cells 102 and 104 denoted as bold line 103). In addition, the monitoring receivers may be located at an end-users receiver (such as the end-users television or computer) or any other appropriate location. The monitoring receivers monitor the level of interference for a given channel.

In some embodiments of the present invention, the system may also include a frequency assignment controller. The frequency assignment controller monitors signal strength and the level of interference by interrogating the monitoring receivers described above. The frequency assignment controller may then alter the frequency assignment of certain cells according to the level of interference and broadcast traffic demand.

In some embodiments, one or more of the transmitting facilities may also include a cache that is capable of storing contents prior to broadcast. In such systems, the information is transferred to the cache before the time for transmission and this may help alleviate congestion on the IP network 302 or at the content server 306. This may be particularly useful in systems that utilize on demand programming because there are times when demand for on-demand programs is increased and if certain programs are already stored at in the cache at the server, the demands on the IP network 302 and the content server 306 may be reduced. Retransmission of any part of the contents, or the entire contents may be done locally between the transmitting facility and the end-users. Retransmission of the contents to another user may be done locally as well.

The above description has been directed to FIG. 10. In general, the system of FIG. 10 is directed to a system that uses an IP network to distribute multimedia contents to particular transmitting facilities. One use of the system is to deliver programming to users utilizing a television set. As one of ordinary skill will readily realize, the information could be delivered to any device capable of receiving an over-the-broadcast such as, for example, a wireless telephone or a computer.

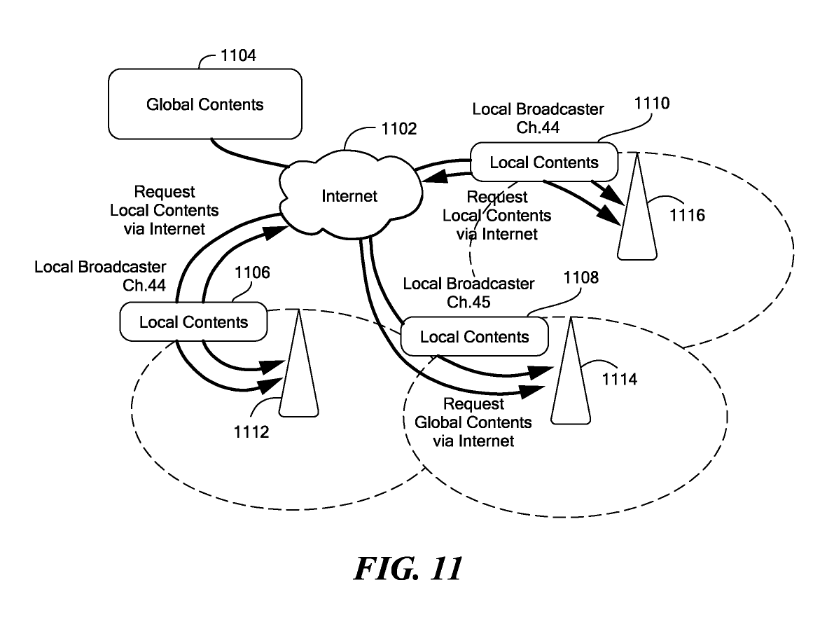

As discussed above, separate content servers can be used to provide some or all of the content for individual cells. Thus, for example, a global content server can be used to provide global information to all cells, and separate local content servers can be used to provide local content to respective cells. FIG. 11 is a schematic diagram showing a representation of a system having a global content server and a plurality of local content servers, in accordance with an exemplary embodiment of the present invention. The system includes three transmitting facilities 1112, 1114, and 1116. Global content is provided to the transmitting facilities from global content server 1104 over network 1102. Local content is provided to each of the transmitting facilities from a local content server. Specifically, local content is provided to transmitting facility 1112 from local content server 1106, local content is provided to transmitting facility 1114 from local content server 1108, and local content is provided to transmitting facility 1116 from local content server 1110.

In order to support local/regional content delivery, the content of a given cell can be logically divided into content classes (e.g., local, regional, global). For example, communications can be segmented (e.g., into slots, packets, etc.), with different segments used for different content classes. Certain segments may be used to transmit mapping information. Transmissions within a cell may utilize a predetermined pattern of segments, for example, a first number of global segments followed by a second number of regional segments followed by a third number of local segments. For example, a sequence of segments may be repeated as a series of frames. Each segment may include a class-of-service indicator, which would enable receiver units to process each segment according to its particular class of service.

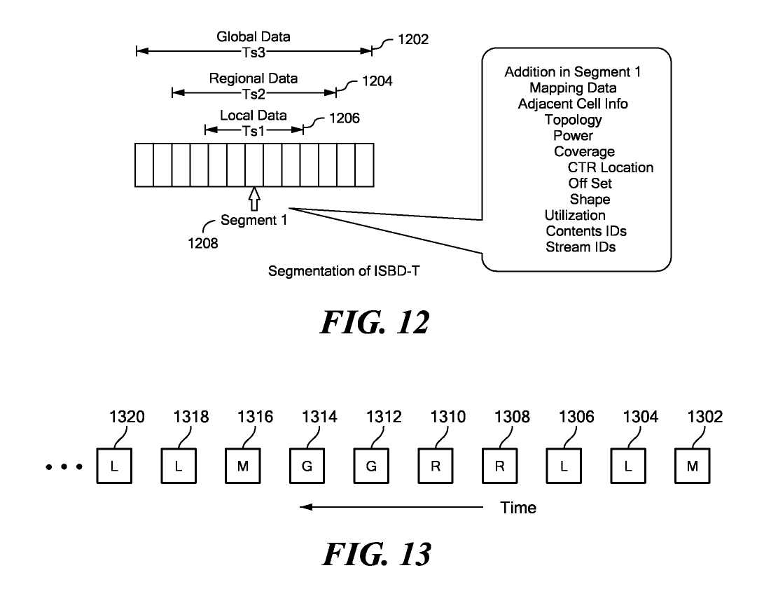

FIG. 12 is a schematic diagram showing a representation of segmented transmissions, in accordance with an exemplary embodiment of the present invention. In this example, transmissions include global data segments 1202, regional data segments 1204, and local data segments 1206. A particular segment 1208 is used to transmit mapping information.

FIG. 13 shows a sequence of transmission segments in accordance with an exemplary embodiment of the present invention. In this example, the transmitted contents may be programmed by a sequence including a mapping segment 1302 followed by two local segments 1304 and 1306, two regional segments 1308 and 1310, and two global segments 1312 and 1314. The sequence may repeat, starting with a mapping segment 1316 followed by two local segments 1318 and 1320, and so on depending on the broadcasted program sequence.

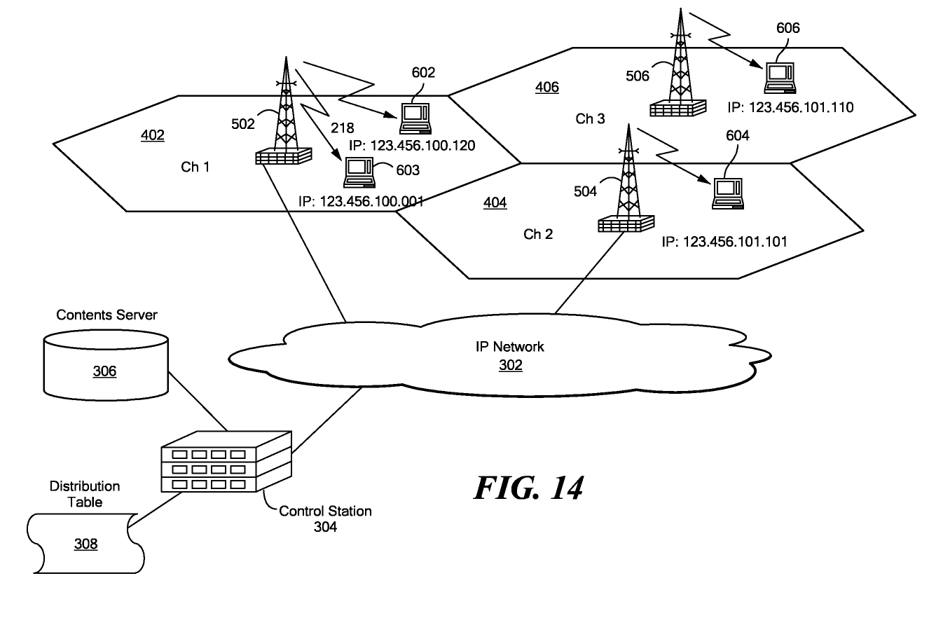

FIG. 14 is a schematic diagram showing a representation of a cellular television system in which IP packets containing multimedia contents are transmitted to the end-user over the air, in accordance with an exemplary embodiment of the present invention. In this example, it is possible, without a response from the end-user receiver, to have the transmitting facility transmit IP packets, for example, by pretending there is connectivity over the physical medium layer and the data link layer. IP packets may be transmitted as broadcast or multicast or by unicast to the end-user receiver IP address which is available prior to the transmission.

The system of FIG. 14 includes a plurality of cells 402, 404, and 406, each of which may have a transmitting facility 502, 504, and 506, respectively. In addition, this system may include a control station 304, a contents server 306, and a distribution table 308. In this example, the distribution table 308 at the control station 304 also includes over-the-air IP addresses for the end-users.

The system of FIG. 14 also includes individual end-users 602, 603, 604, and 606. Some or all of these end-users may have an individual IP address. For example, end-user 602 may have IP address 123.456.100.120, end-user 603 may have IP address 123.456.100.001, end-user 604 may have IP address 123.456.100.101, and end-user 606 may have IP address 123.456.100.110. Each end user may have a receiving device that includes the ability to be uniquely identified by an IP address. Examples include a set-top box or a computer with internet capabilities.

Furthermore, to facilitate sending contents directly to an individual end-user, some or all of the transmitting facilities may also have a router located therein. The router allows for the sending of over-the-air IP packets to a particular end-user. That is, the transmitting station broadcasts IP packets that include a particular address associated with them. These addresses, for example, could reside in the header of each IP packet that is broadcast.

Referring again to FIG. 14, the transmission station 502 could, in one embodiment, send a first packet having a header that correlates to the address of end-user 602 and a second packet having a header that correlates to the address of end-user 603. In this example, the first packet would only be received by end-user 602 and the second packet would only be received by end-user 603.

Furthermore, the transmitting facilities shown in FIG. 14 may also have the ability to perform IP tunneling or other mechanism for forward end-user IP packets through the transmitting facilities. IP tunneling encapsulates the end-users' IP address into the transport packets. In some embodiments, this may allow for communication between the contents server 306 and a particular transmitting facility.

In some embodiments, it may be necessary or desirable for the system to include some upstream connectivity from the end-user receivers to the service provider, for example, to provide acknowledgements in response to downstream messages transmitted by the service provider and/or to enable interactive or on-demand services. Various types of upstream communications can be supported. For example, the service provider may operate a separate network for upstream communications (e.g., a separate wireless network), or upstream connectivity may be provided through existing systems such as the Internet or a telephone network. Upstream communications may support IP connectivity. Upstream communications may be coordinated with downstream communications (e.g., a command/response type protocol) or may be completely independent of downstream communications (e.g., the end user may be permitted to phone in to the service provider to request a particular service). A system may support multiple types of upstream communications, and different end users may use different types of upstream communications to communicate with the service provider. Upstream communication channels are not required to correspond with cells, e.g., the service provide may utilize a single receiver facility to receive upstream communications from multiple cells.

In some embodiments, one or more auxiliary connections used for upstream communications can also be used to receive service information from the service provider. For example, the user may have an auxiliary connection in addition to the over-the-air television connection. In such cases, service information may be delivered to the receiver units via multiple connections. For example, duplicate information may be transmitted to a particular receiver unit over both an over-the-air television channel and an auxiliary connection. In some cases, duplicate information may be carried over different connections. A segment identifier or other mechanism may be used to facilitate detection of duplicate information. For example, if duplicate MPEG2-TS data is transmitted over multiple connections, the packet identifiers of MPEG2 packets received over different connections may be compared to detect duplicate information. In this way, over-the-air traffic may be diversified over the auxiliary connections. Such diversification tends to reduce the over-the-air traffic as well as increasing the security.

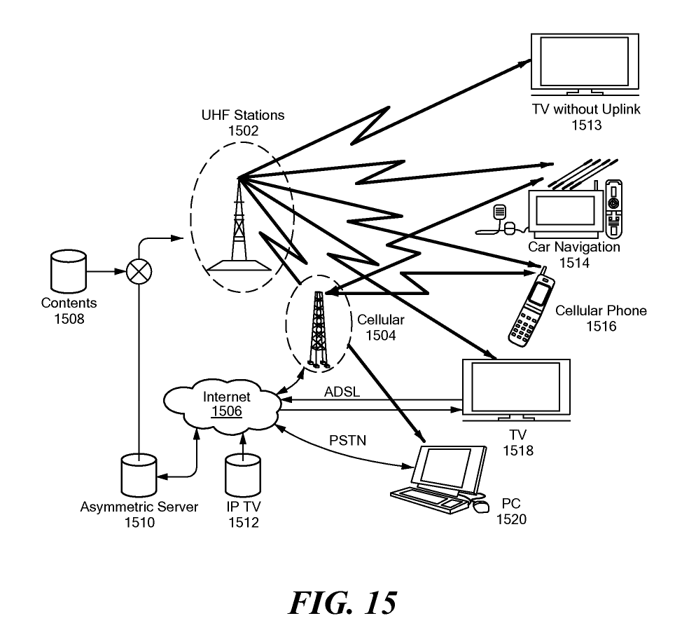

FIG. 15 is a schematic diagram showing a representation of a cellular television system with various types of upstream communications, in accordance with an exemplary embodiment of the present invention. In this example, the system includes UHF transmitting facilities 1502 and 1504 that transmit information from content server 1508 and asymmetric server 1510 to end users 1513, 1514, 1516, 1518, and 1520, which are, respectively, a television without uplink, a car navigation system, a cellular telephone, a television with uplink, and a portable computer. The information may include IP television from IP TV server 1512 provided to asymmetric server 1510 over Internet 1506. The asymmetric server 1510 may also receive upstream communications from the various end users, for example, via cellular telephone from car navigation system 1514 and cellular telephone 1516, via ADSL from home television 1518, and via the public switched telephone network (PSTN) from portable computer 1520. The types of upstream communications depicted in FIG. 15 are examples only, and it will be apparent that other types of upstream communications may be supported (e.g., data-over-cable, WIFI, FTTH, etc.).

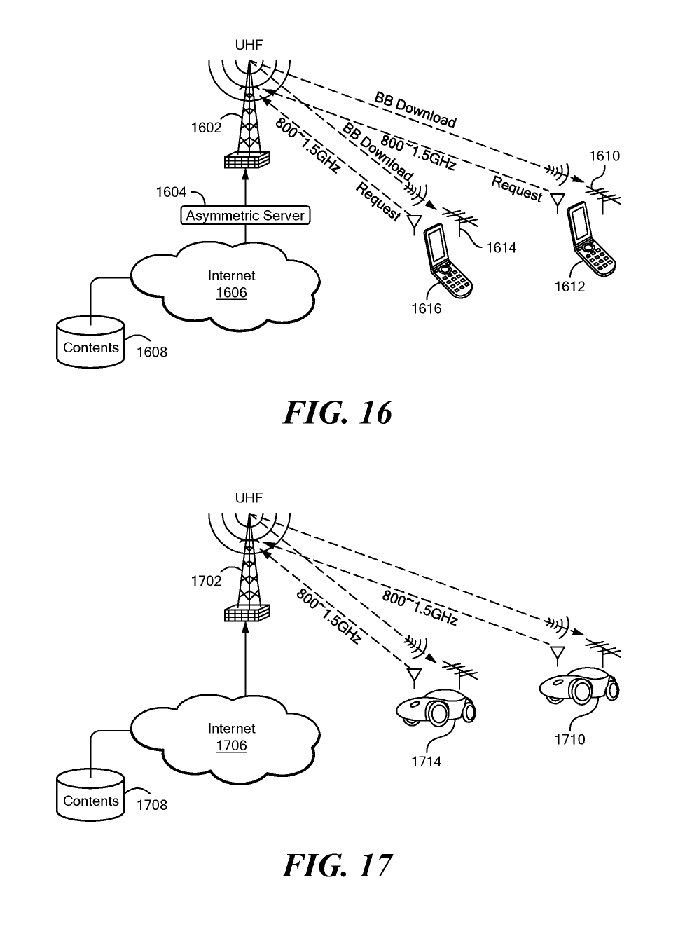

FIG. 16 is a schematic diagram showing a representation of a cellular television system with cellular upstream communications, in accordance with an exemplary embodiment of the present invention. In this example, a UHF transmitting facility 1602 transmit information from asymmetric server 1604 to end users 1610 and 1614. The information may be provided to the asymmetric server 1604 from content server 1608 over the Internet 1606. The end users may use their respective cellular telephones 1612 and 1616 to request specific services.

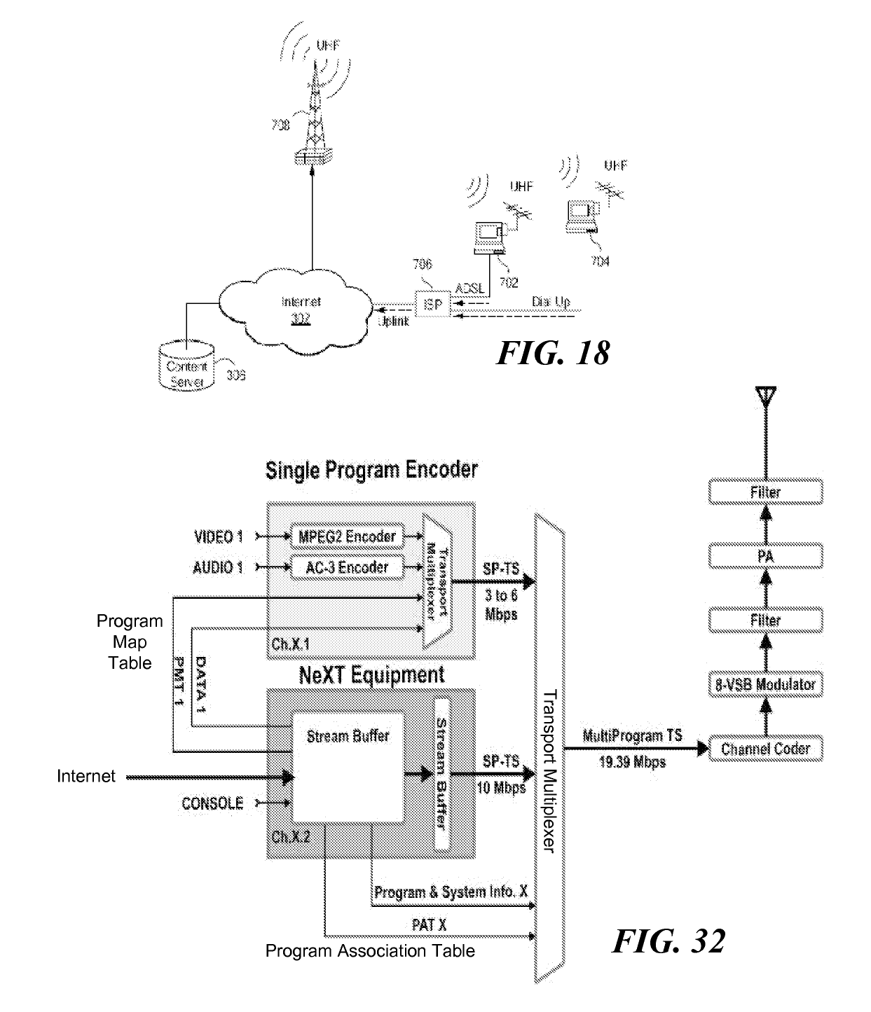

FIG. 17 is a schematic diagram showing a representation of a cellular television system for mobile communications such as navigation, in accordance with an exemplary embodiment of the present invention. In this example, a UHF transmitting facility 1702 transmits information to mobile stations installed or otherwise placed in automobiles 1710 and 1714. The information may be provided to the UHF transmitting facility from content server 1708 over the Internet 1706. The mobile stations may utilize wireless communications to communicate with the service provider.

FIG. 18 is a schematic diagram showing a representation of a cellular television system including upstream communications over an auxiliary IP connection, in accordance with an exemplary embodiment of the present invention. In this example, the system may include first and second end user stations, 702 and 704 respectively. These end user stations may be connected to the IP network 302 (e.g, the Internet) through an internet service provider (ISP) 706. In this example, end user station 702 is coupled to the ISP 706 via an ADSL connection, while end user station 704 is coupled to the ISP 706 via a dial up connection. Of course, other types of connectivity (e.g., data-over-cable, wireless) are possible, and the present invention is not limited to any particular type of upstream connectivity. The upstream connections to the internet allow the end user stations 702 and 704 to communicate with the contents server 306, e.g., for interactive or on-demand services.

In order to receive information services in the cellular television system, receiver units generally need to locate one or more downstream television channels on which to receive service information. Thus, each receiver unit typically includes one or more tuners and a controller. The tuners are generally capable of tuning into any of the various television channels supported by the system, under control of the controller. When the receiver unit is powered on (or at other appropriate times, such as roaming), the controller may command a tuner to tune to a particular channel and/or scan the set of channels assigned to the system in order to locate an appropriate channel on which to receive service information. The controller may measure the signal strength, interference level, bit error rate, frame (block) error rate, or other qualities of various channels to determine the appropriate channel. If an upstream communication channel is available, then downstream channel selection (both initially and during roaming) may involve a more formal hand-off between the service provider and the receiver unit via the upstream communication channel.

As discussed above, a cellular television system may include a number of transmitting facilities that are fed content by one or more content servers. The content servers may be in communication with the transmitting facilities through a network, such as the Internet. It should be noted that the service provider that operates the transmitting facilities may operate one or more of the content servers, but may alternatively or additionally obtain content from various third party servers that may be accessible over the Internet or otherwise.

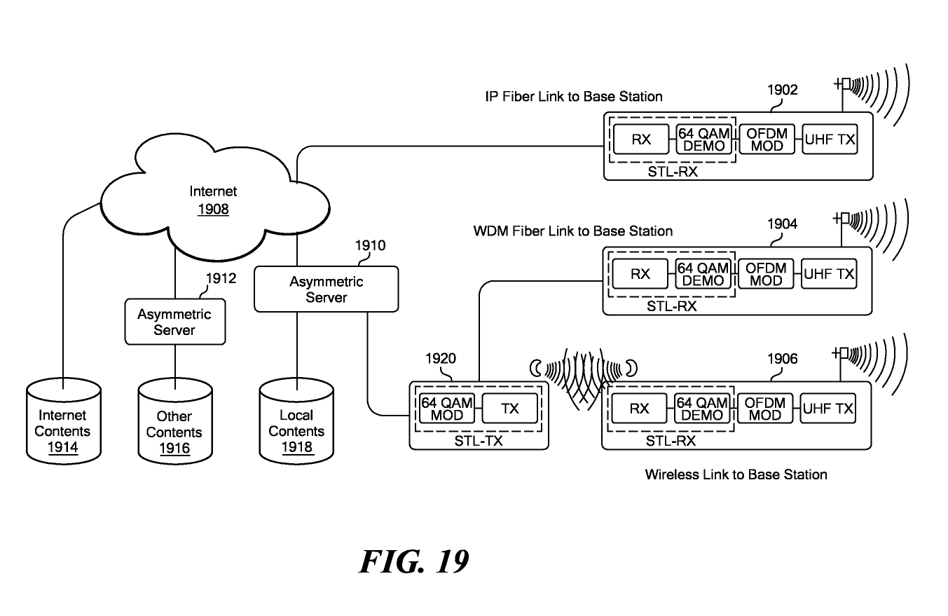

FIG. 19 is a schematic diagram showing some potential equipment configurations at service provider headend, in accordance with an exemplary embodiment of the present invention. In this example, the service provider operates three transmitters 1902, 1904, and 1906. Each transmitter includes similar components, including a receiver for receiving data from the asymmetric servers 1910 and 1912, an OFDM modulator, and a UHF transmitter. The transmitters are coupled with the remainder of the headend components over different types of communication links, from which the transmitters receive content for transmission. Specifically, transmitter 1902 is coupled over an IP fiber link, transmitter 1904 is coupled over a WDM fiber link, and transmitter 1906 is coupled over a wireless link. Content can be provided from an internet server 1914 accessible over the Internet, from local content server 1918, or from other content server 1916.

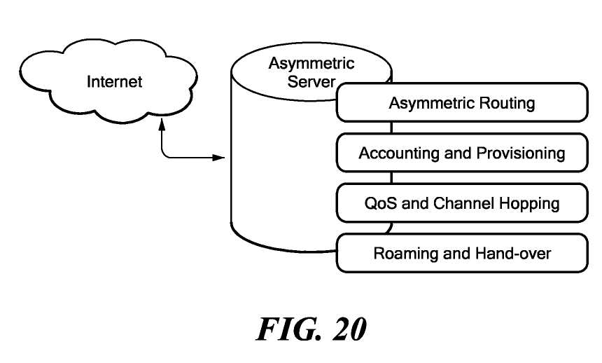

FIG. 20 is a schematic diagram showing a representation of an asymmetric server, in accordance with an embodiment of the present invention. The asymmetric server may provide such functions as asymmetric routing, accounting and provisioning, quality-of-service (QoS) and channel hopping, and roaming and hand-over.

As discussed above, the cellular television system may be implemented as a broadcast-only system (i.e., only from service provider to users) or may be implemented as a two-way system. Thus, receiver units may be implemented as receive-only devices or may be implemented with both receiver and transmitter components. Furthermore, receiver units may be implemented with a single television tuner or with multiple television tuners. In a single tuner implementation, the single tuner would be used for both receiving content and roaming. For example, the single tuner may alternate between an “online” state in which content is received over a current television channel and an “offline” state in which the tuner is used to sample television channels in adjacent cells (e.g., measure signal strength) to determine whether to remain on the current television channel or switch to an alternate television channel. In a multiple tuner implementation, one tuner may be used solely to receive content over a current channel, while a second, separate tuner may be used for roaming. With multiple tuners, roaming can be performed without interrupting receipt of content.

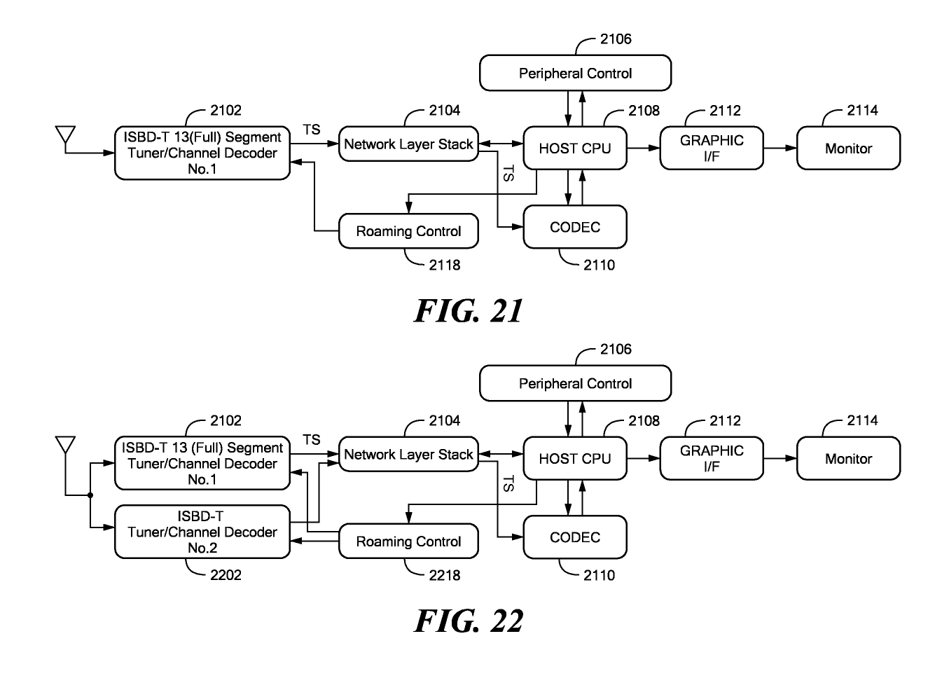

FIG. 21 is a schematic diagram showing the relevant components of a receiver unit having a single television tuner, in accordance with an exemplary embodiment of the present invention. Among other things, the receiver unit includes a tuner 2102, a network layer stack 2104, peripheral control 2106, host CPU 2108, coder/decoder (CODEC) 2110, graphic interface 2112, monitor 2114, and roaming control 2118. In this example, the single tuner 2102 is typically used for both receiving content and roaming. Therefore, the tuner 2102 may be controlled by the roaming control 2118 so as to alternate between an “online” state in which content is received over a current television channel and an “offline” state in which the tuner is used to sample television channels in adjacent cells (e.g., measure signal strength) to determine whether to remain on the current television channel or switch to an alternate television channel. The roaming controller is controlled by CPU 2108.

FIG. 22 is a schematic diagram showing the relevant components of a receiver unit having two television tuners, in accordance with an exemplary embodiment of the present invention. Among other things, the receiver unit includes a first tuner 2102, a second tuner 2202, a network layer stack 2104, peripheral control 2106, host CPU 2108, coder/decoder (CODEC) 2110, graphic interface 2112, monitor 2114, and roaming control 2118. In this example, the tuner 2102 is typically used solely for receiving content over a current television channel, while the receiver 2202 is typically used solely to sample television channels in adjacent cells to determine whether to remain on the current television channel or switch to an alternate television channel. The roaming control 2218 controls sampling by the tuner 2202 and switching channels by the tuner 2102. The roaming controller is controlled by CPU 2108. By using two tuners, sampling and switching channels can be accomplished without service interruption.

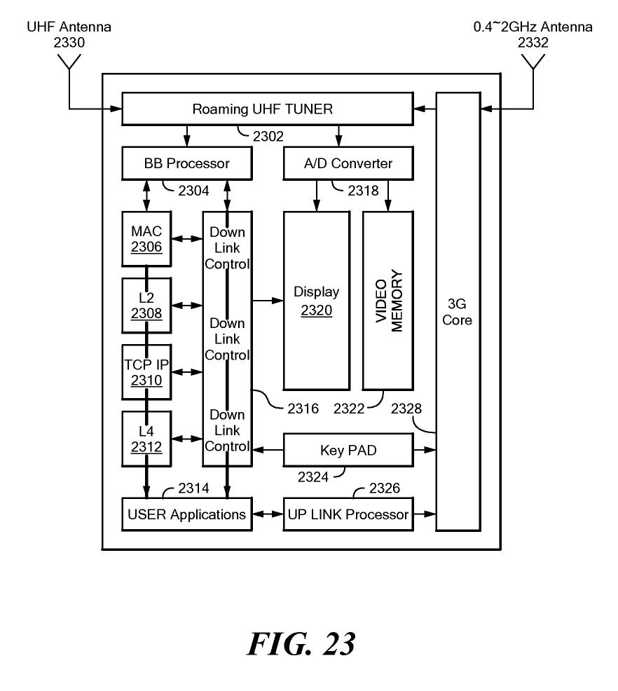

FIG. 23 is a conceptual block diagram showing the relevant components of a receiver unit including upstream communication support (e.g., a cellular telephone or other portable device with wireless transmitter), in accordance with an exemplary embodiment of the present invention. The receiver unit includes a roaming UHF tuner 2302; a broadband processor 2304; a protocol stack including MAC layer 2306, link layer (L2) 2308, IP layer 2310, transport layer (L4) 2312; user applications 2314; downlink control 2316, analog-to-digital (A/D) converter 2318; display 2320; video memory 2322; key pad 2324; uplink processor 2326; and 3G core 2328. The UHF tuner 2302 may include a single tuner or multiple tuners. The roaming UHF tuner 2302 can receive signals from both the UHF antenna 2330 and the cellular antenna 2332. Those signals are processed by the broadband processor 2304 and/or the A/D converter 2318, and may be processed through the protocol stack 2306-2312 to the user applications 2314 under control of the downlink control 2316. The user applications 2314 may generate upstream communications via uplink processor 2326 and 3G core 2328. The upstream communications may include such things as protocol acknowledgments, requests for on-demand services, requests for interactive services, and information regarding qualities of the downstream broadcast television channel(s), to name but a few. At any of the various stages of processing, certain information may be stored in video memory 2322 and/or displayed on display 2320. Also, the user may interact with user applications 2314 through keypad 2324.

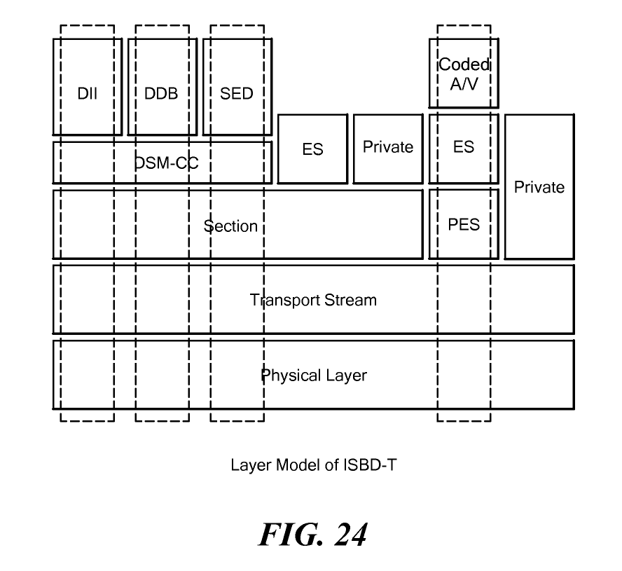

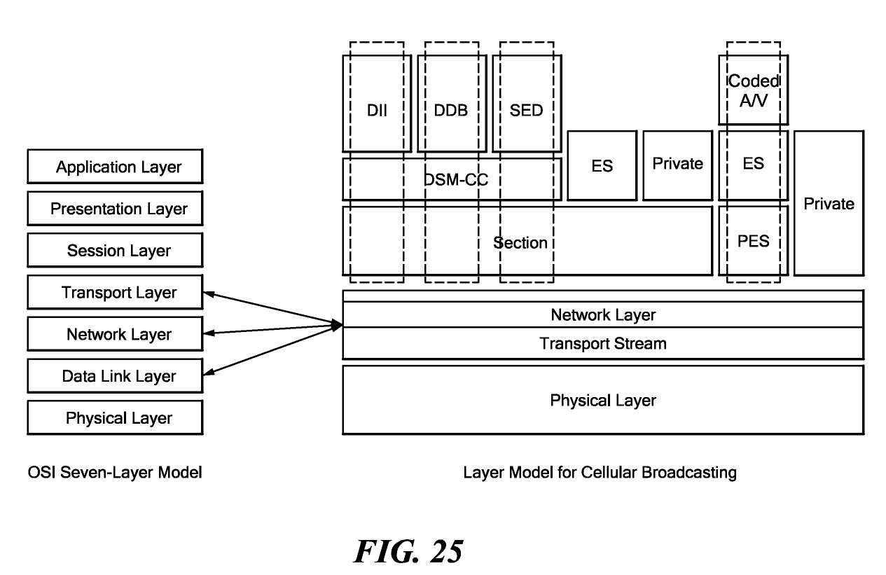

It should be noted that different embodiments of the present invention can use different cellular broadcasting protocols while remaining within the scope of the present invention, and thus the present invention is not limited to any particular protocol. FIG. 24 shows a representation of the layer model for the ISBD-T protocol as known in the art. FIG. 25 shows a representation of the layer model for a cellular broadcasting protocol in accordance with an exemplary embodiment of the present invention.

As discussed above, embodiments of the present invention can be used to provide any of a wide variety of information services, and the present invention is in no way limited to any particular information service(s). Embodiments of the present invention are also particularly useful for delivering localized information content, although the present invention is not limited to delivery of localized content. In fact, as discussed above, the same content may be transmitted across multiple cells, in which case the cellular television system can provide for continuity of service across part or all of the system, perhaps extending beyond the coverage area of a traditional broadcast television service or covering specific geographic areas that would be impossible with a traditional broadcast television service (e.g., covering suburbs around a city but not covering the city itself).

One example of an information service that can be provided using a cellular television system is real-time delivery of local navigation information, e.g., for navigation systems outfitted with cellular television support. Specifically, each cell may transmit local navigation information regarding such things as roadways, store locations, and public transportation, to name but a few. In particular, each cell may transmit detailed, up-to-date information regarding dynamic events that affect navigation within the coverage area of the cell, including such things as road closings, detours, accidents, construction, and traffic conditions, to name but a few Such dynamic events may be transitory, may change frequently, and are generally of interest only to users in or around the particular area affected.

Another example of an information service that can be provided using a cellular television system is targeted advertising. Specifically, each cell may transmit localized advertising information, e.g., to cell phones, PDAs, portable computers, or other devices outfitted with cellular television support. The localized advertising may include such things as incentives, offers, coupons, and discounts for local businesses. Because users may be transitorily within a particular cell, advertisements could be time limited (e.g., anyone who visits business X within the next 15 minutes and presents an advertised offer number gets a free gift). An exemplary business model for such a cellular television system might include the sale of advertising slots in individual cells. In this way, local businesses could advertise in a limited area within which they operate (and within which any users receiving the advertisements will necessarily be located, making it more likely that those users would visit those businesses), and therefore might be more inclined to spend money on advertising compared to advertising in a traditional television broadcast system (which might be more expensive due to the larger coverage area but with less success because the advertisements reach many users who are not in the immediate area of the business). In such a business model, the set of advertisements received by a particular user would typically change as the user moves from one cell to another.

Yet another example of an information service that can be provided using a cellular television system is uninterrupted television service across cells. Currently, many television broadcasting companies operate transmitting facilities in different cities that transmit essentially the same programs on different channels. For example, the American Broadcasting Company operates Channel 5 in the Boston, Mass. area and operates Channel 6 in the Providence, R.I. area, and the coverage areas of these channels are not only adjacent to one another, but partially overlap such that users in certain areas can receive both channels. Such television services are not “cellular” within the present context, however, because, among other things, the transmitting facilities do not transmit mapping information that would enable mobile receiver units to transition between cells in order to maintain service. In exemplary embodiments of the present invention, mapping information would be transmitted along with the television program in each cell so that receiver units (e.g., television sets with cellular television support) could automatically switch from one channel in one cell to a related channel in another cell in order to provide essentially uninterrupted viewing of a television program across cells.

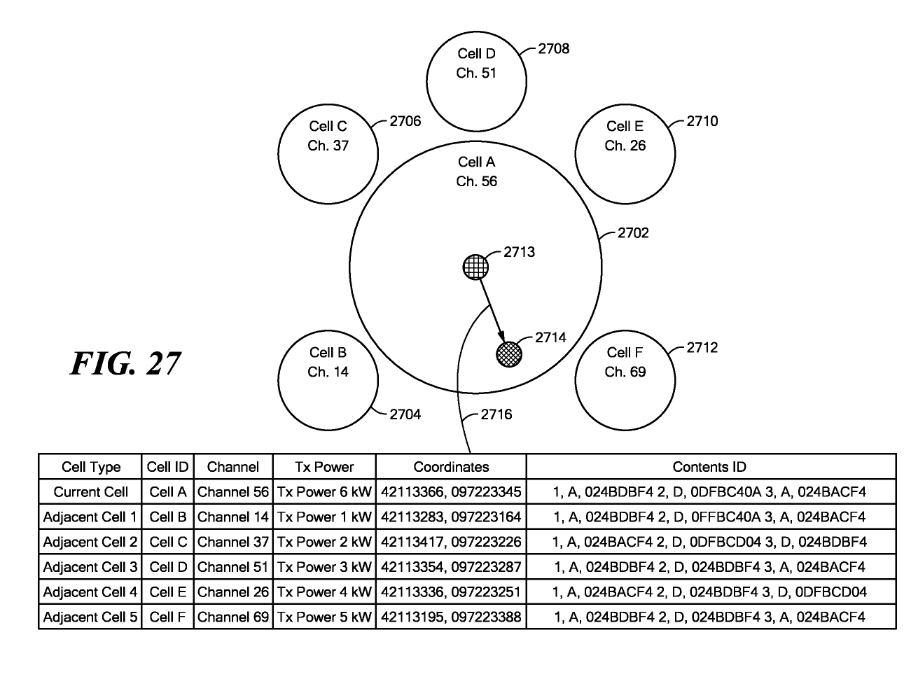

FIG. 27 is a schematic diagram showing a representation of a cellular television system transmitting mapping information, in accordance with an exemplary embodiment of the present invention. In this example, the cellular television system includes six cells, namely Cell A 2702, Cell B 2704, Cell C 2706, Cell D 2708, Cell E 2710, and Cell F 2712. The cells operate on UHF television channels 56, 14, 37, 51, 26, and 69, respectively. As discussed above, each cell transmits mapping information including adjacent cell information and optionally including additional information, such as information about the current cell (such as information regarding topology, power, coverage, CTR location, offset, shape, utilization) as well as information regarding the service information (such as contents identifiers, transport stream (TS) identifiers, and stream types). For example, transmitter 2713 in Cell A 2702 may transmit mapping information 2716 as follows:

| | Cell | | | | |
|---|---|---|---|---|---|
| Cell Type | ID | Channel | Tx Power | Coordinates | Contents ID |
| Current | Cell A | Channel | Tx Power | X, Y, Z | TS, TYPE, |
| Cell | | 56 | 6 kW | | CONTENTS |
| Adjacent | Cell B | Channel | Tx Power | | |
| Cell 1 | | 14 | 1 kW | | |
| Adjacent | Cell C | Channel | Tx Power | | |
| Cell 2 | | 37 | 2 kW | | |
| Adjacent | Cell D | Channel | Tx Power | | |
| Cell 3 | | 51 | 3 kW | | |
| Adjacent | Cell E | Channel | Tx Power | | |
| Cell 4 | | 26 | 4 kW | | |
| Adjacent | Cell F | Channel | Tx Power | | |
| Cell 5 | | 69 | 5 kW | | |

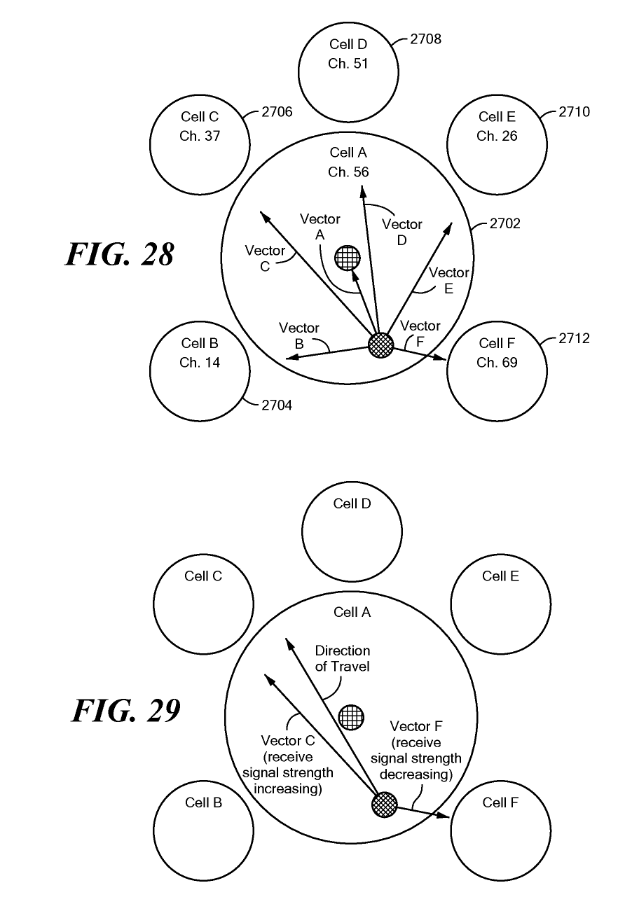

The mapping information 2716 may also include coordinates and/or contents identifiers associated with adjacent cells. A mobile receiver unit 2714 in Cell A can use the mapping information 2716 to identify attributes of the various cells, such as the channels associated with adjacent cells. The mobile receiver unit 2714 may periodically test some or all of the adjacent cell channels, as indicated in the mapping information 2716, and evaluate the quality of each adjacent cell channel relative to the quality of the channel in the current cell and/or relative to the qualities of other adjacent cell channels. For example, the mobile receiver unit 2714 may generate a vector for each cell, as shown in FIG. 28. The vectors could be based solely on a single parameter (e.g., receive signal strength) or could be based on multiple parameters (e.g., receive signal strength, transmit power, direction, etc.). The mobile receiver unit 2714 may use channel analysis for such things as making roaming decisions, estimating its location within the current cell, and estimating direction of travel, to name but a few.

For example, the mobile receiver unit 2714 might determine, based on the channel analysis, that it is closest to one particular adjacent cell (say, adjacent Cell F 2712), for example, based on receive signal strength measurements of the adjacent cell channels. The mobile receiver unit 2714 might therefore conclude that it is located in the portion of the current cell nearest that adjacent cell (in this case, the southeast portion of Cell A 2702, which is nearest Cell F 2712).

The mobile receiver unit 2714 may also determine, based on the channel analysis, that it is moving away from a first adjacent cell (e.g., the receive signal strength associated with the first adjacent cell channel, say, Ch. 69 associated with adjacent Cell F 2712, is becoming weaker over some period of time) and is moving toward a second adjacent cell (e.g., the receive signal strength associated with the second adjacent cell channel, say, Ch. 37 associated with adjacent Cell C 2706, is becoming stronger over some period of time), as shown in FIG. 29. The mobile receiver unit 2714 might therefore conclude that it is moving in the direction from the first adjacent cell toward the second adjacent cell (in this case, in a northwest direction from Cell F 2712 toward Cell C 2706).

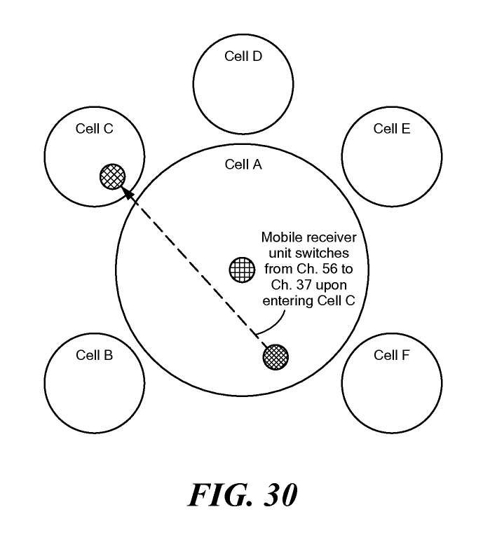

At some point, the mobile receiver unit 2714 might determine, based on the channel analysis, that it has “roamed” from the current cell to an adjacent cell (e.g., the receive signal strength of the adjacent cell channel, say, Ch. 37 associated with Cell C 2706, is greater than the receive signal strength of the channel in the current cell, which in this example is Ch. 56 associated with Cell A 2702), as shown in FIG. 30. In this case, the mobile receiver unit 2714 generally transitions to the channel operating in the adjacent cell (in this case, Ch. 37 associated with Cell C 2706) so as to begin receiving content and mapping information from the new cell. For example, the transmitter in Cell C 2706 may transmit mapping information as follows:

| Cell Type | Cell ID | Channel | Tx Power | Coordinates |
|---|---|---|---|---|
| Current Cell | Cell C | Channel 37 | Tx Power 2 kW | X, Y, Z |
| Adjacent Cell 1 | Cell A | Channel 56 | Tx Power 6 kW | |
| Adjacent Cell 2 | Cell B | Channel 14 | Tx Power 1 kW | |
| Adjacent Cell 3 | Cell D | Channel 51 | Tx Power 3 kW | |
| . | . | . | . | |
| . | . | . | . | |
| . | . | . | . | |

The mapping information may include coordinates and/or contents identifiers for one or more of the various cells. Thus, channel analysis can be used as a form of positioning system by which the mobile receiver unit can roam from cell to cell, estimate its position within the cellular television system, and estimate its direction of travel within the cellular television system. Furthermore, the mobile receiver unit can transmit positioning information back to the service provider. The service provider can use the received positioning information for such things as real-time tracking of the mobile receiver unit, locating the mobile receiver unit (e.g., in an emergency situation), and providing location-specific content to the mobile receiver unit, to name but a few. The service provider can route the contents to the destination cell before the roaming receiver starts downloading the contents from the destination cell.

The mobile receiver may correlate channel measurements (e.g., receive signal strength) with direction or positioning information (e.g., GPS information). Such correlations can provide additional information from which the mobile receiver can make roaming decisions.

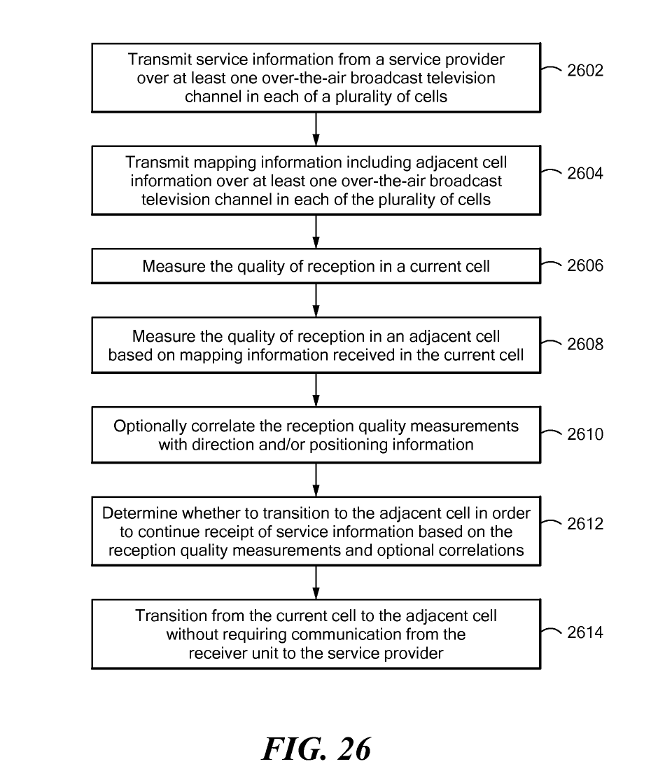

FIG. 26 is a logic flow diagram describing a method for providing information services in a cellular television system, in accordance with an exemplary embodiment of the present invention. In block 2602, service information from a service provider is transmitted over at least one over-the-air broadcast television channel in each of a plurality of cells. In block 2604, mapping information including adjacent cell information is transmitted over the at least one over-the-air broadcast television channel in each of the plurality of cells. In block 2606, the quality of reception in a current cell is measured. In block the quality of reception in an adjacent cell is measured, based on mapping information received in the current cell. In block 2610, the reception quality measurements are optionally correlated with direction and/or positioning information (e.g., based on channel analysis or GPS information). In block 2612, a determination is made whether to transition to the adjacent cell in order to continue receipt of service information based on the reception quality measurements and optional correlations. If the determination is made to transition to the adjacent cell, then, in block 2614, the transition is made from the current cell to the adjacent cell without requiring communication from the receiver unit to the service provider.

It should be noted that the coordinates included in the mapping information can include absolute coordinates (e.g., longitude/latitude or GPS coordinates) or relative coordinates (e.g., Cell B 2704 is southwest of Cell A 2702).

As discussed above, the effective coverage area of a single-channel licensed broadcast television system can be split into multiple cells, with some cells operating on the same channel (e.g., under the existing license) and some cells operating on one or more different channels. Cells also may be arranged to cover areas between existing single-channel broadcast television systems. Cells may utilize unused television channels (so-called “whitespace”) in and between licensed coverage areas. In various embodiments, cells transmitting on the same television channel may be synchronized or may operate asynchronously.

FIG. 31 is a schematic diagram showing a network configuration in accordance with an exemplary embodiment of the present invention. Among other things, the network includes a local broadcasting station 3110 (in this example, a UHF broadcasting station) that receives advertising from existing advertising channels 3120 and also interfaces with various servers 3140 (e.g., a premium contents server, a unified call connector server, and an asymmetric server) via the Internet 3130 or otherwise. The premium contents server may provide such things as free content, subscription-based or pay-per-view content, on-demand content, etc. The UCC server may provide for messaging and other communication services. The asymmetric server may provide for interactive Internet access services. The local broadcasting station 3110 includes a production facility 3111 that generates local (foreground) contents stored in a content server 3112 and also includes a location based service (LBS) router 3113 for selectively distributing both locally-stored and remotely-stored content to the towers 3114-3117. As will be described below, the LBS router 3113 may distribute specific content to a single tower, to a group of towers, or to all towers, and different content may be distributed to different sets of towers (e.g., first content distributed to all towers, second content additionally distributed to towers 3114 and 3115 only, third content additionally distributed to tower 3114 only, etc.). Also as will be described below, interactive services may be provided using any of a variety of return/request channels. For the sake of convenience, such return/request channels are not shown in the figure.

In one exemplary embodiment, a service provider operates the cellular television system (or a portion thereof) for providing multiplexed digital television broadcast channels over the shared distribution transmission architecture. This service provider may host one or more participating television licensees. The service provider may transmit the licensees' free-to-air (FTA) video channels simultaneously from all or some of the cell sites, with the spare data capacity pooled so as to enable marketing of additional value added services. Among other things, such an arrangement may generate revenue-sharing income streams not otherwise available to small independent operators.

Broadcasters typically are creators and owners of a wide range of content, e.g., both new content produced daily and archives of past programming. An alliance, for example, operated by a third party service provider, may operate as a clearinghouse and digital rights management administrator for these and other content sources. As discussed below, the ability of the cellular television system to provide national outlets on a community-by-community basis can add substantial value to the content produced and developed by the wider community of interest represented by the third party service provider.

In any case, broadcasters may be required (e.g., by regulation) to transmit at least one video signal from each tower, but transmission of a single digital television signal should still leave large amounts of bandwidth available for analog and/or digital services. Thus, in a cellular television system, a television signal may be distributed to and transmitted by multiple towers, but otherwise each tower may transmit other content, e.g., on a national, regional, or local scope. Each tower may act as a beacon for transmitting information regarding which channels are used or need to be avoided and/or which channels are open or available (e.g., advertise used channels, advertise “whitespace,” and/or advertise a suggested return channel for user-to-system traffic). Each tower may transmit on multiple channels and may use standard transmission formats, e.g., ATSC standards, such that the signals can be received by standard digital receivers. Bandwidth from multiple television stations may be aggregated.

Generally speaking, the cellular television system may support a variety of services such as, for example, television in both standard definition and high definition formats, high fidelity audio services, information broadcasting and downloading services, interactive services (e.g., Internet access, on-demand services, opt-in services), video advertising, video billboard, location-based services, and messaging, to name but a few. For interactive services, various types of return/request channels (e.g., cellular, WiMAX, fixed line) may be supported for communication from the user(s) back to the system. Services may be provided on a free-to-air (FTA) basis (e.g., privately or publicly funded, advertising supported, etc.) and/or on a pay basis (e.g., subscription, pay-per-view, etc.). Operating expenses of cell site rental and collocation charges on existing antennas can be offset, for example, by advertising revenue and/or user fees. Furthermore, the ability to leverage a shared infrastructure that may be located primarily on public real estate and tower facilities can provide revenue for municipalities while at the same time enhancing the public benefit (e.g., by providing local content, emergency notifications, etc.).

The system may obtain usage information from the various receivers or otherwise track usage so as to allow for statistical analysis of such things as content/channels viewed, location, etc. Such statistical analysis may be used, for example, to adjust content distribution patterns, to adjust advertising prices, or to select locations for additional transmitters, to name but a few.

A peer-to-peer (P2P) network may be used to distribute advertisements and other content to appropriate server(s). Content may be distributed to a single server, a group of servers, or even all servers (perhaps even nationwide). Certain types of content may be distributed on a real time basis, e.g., Internet content, on-demand services, streaming video/audio, etc.

With regard to large (e.g., national) advertisers and content providers, the cellular television system can provide additional outlets and revenue opportunities. Since content easily can be distributed throughout the cellular television network, advertisers and content providers can choose to broadcast in areas and markets that they otherwise might have skipped.

In one exemplary embodiment, a service provider may sell national advertising that is otherwise not available to small local/metropolitan scale television station operators. In this context, the cellular television system can enable the economies of scale required to attract mass audience national advertisers.

Additionally, the cellular television system is also useful for broadcasting locally-generated or locally-oriented content, such as, for example, local advertisements, local programs, emergency notifications, messages, public service announcements, local government notices, local events, mobile services, real-time information services, location-based services, etc. In this regard, the cellular television system can provide an expanded revenue base by providing individuals and local organizations with the ability to participate. Pricing may be on a tiered basis, e.g., price X for advertising to a single neighborhood, price Y for advertising to a group of neighborhoods, price Z for advertising to an entire town, etc. The cellular television system also should be able to distribute emergency alerts and similar content to all devices attached to the network within a few seconds.

In order to support locally-generated content, certain embodiments of the present invention include an automated content creation web server. With reference again to FIG. 31, this automated content creation web server may be part of the production facility 3111 and may generate foreground contents 3112 based on advertising information received from the advertisers 3120 as well as from users via the Internet 3130. Through this web server, a user can specify content for the broadcast (e.g., text, pictures, video, audio, etc.) and also specify the locale(s) and other parameters for the broadcast (e.g., neighborhood, town, specific tower, etc.), and the web server automatically generates the broadcast and distributes it to the appropriate server(s) in the system for transmission over the appropriate tower(s). The web site can support both uploading of user-generated content (e.g., an audio/video file to be broadcast) and automated creation of content (e.g., the user specifies text for an advertisement and the web site automatically generates the content). Thus, for example, an individual could log into the web server, upload and/or create content (e.g., an advertisement for an event such as a yard sale or tournament, an advertisement for a local business such as a sale or coupon, a message, etc.), specify where the content should be displayed (e.g., in the individual's town, county, state, neighborhood, etc.), specify when or how long the content should be displayed (e.g., display N times or display until date X), and pay a small fee (e.g., by credit card, PayPal™, on account, etc.), all with little or no human intervention at the service provider site. The web server may include templates and/or other tools to facilitate content creation.

As discussed above, each transmitter typically transmits mapping data to allow for passive handoff, and each transmitter may act as a beacon for distributing channel availability information. The mapping data and channel availability information may be based not only on topology information (e.g., transmitter location, transmit power, known obstacles such as mountains and buildings, etc.) and third party whitespace information (e.g., information available from the FCC, which may be requested from time to time by the service provider) but also on real-world measurements (e.g., actual reception information at various locations). In fact, receiving terminals may transmit information to the service provider such as, for example, the location of the terminal and power measurements for various channels (e.g., a receiver at a particular address or location may indicate that it is receiving signals on channels A, B, and C with signal strengths X, Y, and Z respectively), and this information can be correlated with information provided from other sources to produce the mapping data and whitespace information database. In this way, a very accurate view of the RF landscape can be compiled.

Also as discussed above, the same content may be transmitted on different television channels within the same cell and/or in different cells. Receivers may choose to receive content from one of a number of channels, for example, based on signal strength (e.g., select the channel with the strongest signal), channel error rates (e.g., select the channel with the lowest packet loss rate), direction of travel (e.g., select a channel that is in the general direction of travel so that the receiver is moving toward rather than away from the selected channel), etc. For example, a mobile receiver may switch between two channels, e.g., as the relative signal strengths change as the receiver moves from place to place. If the mobile receiver needs to choose between two channels of relatively equal signal strength, the mobile receiver may choose a channel that is in the expected direction of travel. Even a stationary receiver may switch between channels, e.g., if one channel is temporarily experiencing interference. A terminal having multiple receivers may receive the same content on two or more channels and may use the redundant information for aggregation into a single stream, e.g., for increased reliability of reception (i.e., essentially combining two or more streams into a single stream). Similarly, user terminals may support multiple types of physical media (e.g., television receiver, Ethernet port, cellular telephone receiver, ADSL or cable modem, etc.) and their respective data link layers, and the terminal may receive the same content on two or more media and may use the redundant information for aggregation into a single stream, e.g., for increased reliability of reception (i.e., essentially combining two or more streams into a single stream).

As discussed above, the transport streams generally include information (e.g., packet sequence numbers) that allow the receiver to pick up the content without an upstream handover. It should be noted that when a receiver switches from an old channel to a new channel, the new channel may be at substantially the same location in the content so that the receiver can make a substantially seamless transition, the new channel may be behind the old channel so that the receiver may introduce a pause until the new channel catches up to the information already received from the old channel, or the new channel may be ahead of the old channel so that the receiver may miss some content.

It should be noted that multiple content streams may be multiplexed into a single transport stream such as MPEG2 or H.264 (MPEG4). In transport streams used for digital television, the main program is typically required to be on a specified subchannel 1 (e.g., for digital channel 6, the main content might be on subchannel 6.1), while other content can be provided on other subchannels. When moving from one cell to another, particular content may be on different subchannels of different channels (e.g., in cell 1, the content might be on channel 6.1 while in cell 2, the same content might be on channel 9.4). The channel/subchannel mappings are broadcast as part of the topology data.

As discussed above, certain embodiments of the present invention may use a P2P network to distribute content, advertisements, and other information. In certain embodiments, the P2P network may be logically organized in a hierarchical manner, e.g., a “supernode” may be included for every N peer nodes (e.g., N=5), a “super-supernode” may be included for every M supernodes (e.g., M=5), etc., with communications for a particular peer node going through its respective supernode and communications for a particular supernode going through its respective super-supernode, etc. Among other things, the supernodes may serve routing information, e.g., when a peer node sends a request for communication with a remote peer node, the corresponding supernodes exchange routing information so that the correct routing methods are used. Also, the supernodes and super-supernodes typically handle security and other administrative functions (e.g., authenticating and documenting the source of information, such as authenticating the source of an emergency notification and obtaining approval to transmit the emergency notification from an appropriate government agency), while also offloading some traffic from the peer nodes. The various nodes in the P2P network are typically referred to using aliases, so that the underlying IP addresses can change. The supernodes typically employ a “heartbeat” mechanism to test for connectivity and to help with identifying network problems.

The P2P network also may support logical tiers for file sharing and other applications. For example, file sharing among a limited number of peers (e.g., 5) may be provided free of charge with no copyright or licensing fees, while open file sharing may be provided for a fee. Conveniently, the logical tiers may be tied to the supernodes described above, e.g., file sharing among the nodes under a particular supernode may be provided free of charge while file sharing from one of those nodes to a node under a different supernode may involve a charge.

The P2P network generally allows information to be stored in multiple locations, for example, duplicated for backup purposes or distributed for load balancing. Thus, file sharing and other applications may involve accesses to multiple peer sites.

In exemplary embodiments of the present invention, appropriate software/firmware (typically provided by the server provider) can be installed in a user's broadband router to configure it for use in the P2P network. In essence, the router becomes a P2P peer node for sending and/or receiving information. In this way, each user may be able to provide content (e.g., streaming video) and/or services (e.g., file storage) to other peers. The user may be charged a fee (e.g., a monthly fee) for such use of the P2P network.

A content provider may want to allow its content to be used by others, perhaps for a small fee. Thus, certain embodiments of the present invention support tagging of content to identify particular content as being available and also to track usage of the content. A tag may be in the form of a digital watermark or similar information embedded in the content. Tagged content should be free of third party rights (e.g., copyrights), and the system may require that the content provider make a certification to that effect. Tagging may operate hierarchically, e.g., content A may include a first tag and content B including tagged content A may include a second tag, etc., such that a royalty can be paid for content A every time content B is used.

A media exchange system may be utilized in which content (tagged or otherwise) is stored for use by others. Access to the media exchange may be subscription-based (e.g., monthly fees), use-based (e.g., a price for each item used), or otherwise. A subscription-based service can allow for tracking the source of content and/or the distribution of content.

Content may be screened/filtered for such things as expletives, pornography, harassing remarks, etc. Such screening/filtering may be done locally (e.g., by an advertisement creation web server or by a P2P peer node router) or may be done elsewhere in the system, e.g., in real time or in a background process.

As discussed above, the broadcast medium allows information to be “pushed” to the users. For example, advertisements, sponsorships, notifications, and other information may be pushed to the users. Furthermore, the pushed information may be added to content obtained from other service providers, e.g., overlayed, superimposed, or otherwise added to content provided by other service providers. For example, television stations, web sites, search engines, and other content providers typically include their own advertisements, but the cellular television broadcaster may have its own separate advertisements, and those advertisements may be included with content provided to the users or may even replace advertisements in the original content. The provider of the original content may be charged a fee if it wants its own advertisements to pass through to the user.

FIG. 32 is a schematic diagram showing the relevant components of a transmission system in accordance with an exemplary embodiment of the present invention. Here, a traditional television broadcast provided for one subchannel of a digital television broadcast via the single program encoder and additional content and services provided for one or more other subchannels (via the equipment referred to as NeXT Equipment) is multiplexed and encoded into a single digital television broadcast transport stream, which is then transmitted using conventional television broadcasting equipment.

As discussed above, some services (e.g., Internet access, peer-to-peer file sharing, media exchange) may be provided in whole or in part at a cost to the user. Such cost could be monetary (e.g., billed monthly, prepaid by credit card, etc.) or virtual (e.g., paid for by points/credits obtained through usage of the system). Points/credits may be amassed in various ways, such as, for example, by viewing advertisements, forwarding advertisements to others, referring others to a service, or adding content to the media exchange). Thus, conceivably, a service could be provided completely without any money and hence without the attendant complexities of collecting money, managing bank accounts, and protecting users' personal information. For example, a new user might be required to view a certain number of advertisements (and hence could generate revenue from the advertisers) until the user has amassed a certain amount of credits, at which time the user could opt to use credits rather than viewing future advertisements until the credits have been depleted. Users may be permitted to trade credits for access to user-based content (e.g., person A might “charge” other users one credit to access person A's content via the peer-to-peer network or media exchange, and the system could effectuate the transfer and maintenance of credits between users by deducting credits from those who access person A's content and adding those credits to person A's account).

It should be noted that, while exemplary embodiments are described above with reference to content servers and transmitting facilities that are coupled over layer 3 networks (e.g., IP networks), the present invention is in no way limited to layer 3 networks. For example, the at least one content server and the transmitting facilities may be coupled over a layer 2 network.

It should also be noted that terms such as “router” and “server” are used herein to describe various communication devices that may be used in a communication system, and should not be construed to limit the present invention to any particular communication device type. Thus, a communication device may include, without limitation, a bridge, router, bridge-router (brouter), switch, node, server, computer, or other communication device.

It should also be noted that the term “packet” is used herein to describe a communication message that may be used by a communication device (e.g., created, transmitted, received, stored, or processed by the communication device) or conveyed by a communication medium, and should not be construed to limit the present invention to any particular communication message type, communication message format, or communication protocol. Thus, a communication message may include, without limitation, a frame, packet, datagram, user datagram, cell, or other type of communication message.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In a typical embodiment of the present invention, some or all of the described logic is implemented as a set of computer program instructions that is converted into a computer executable form, stored as such in a computer readable medium, and executed by a microprocessor within a computer under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present invention may be embodied in other specific forms without departing from the true scope of the invention. The described embodiments are to be considered in all respects only as illustrative and not restrictive.

What is claimed is:

1. A cellular television broadcasting system comprising a first transmission station including a first location-based service router and a first plurality of television transmitters in communication with the location-based service router, each television transmitter configured to transmit content received from the location-based service router over at least one designated over-the-air broadcast television channel, wherein the location-based service router is configured to distribute common content to all of the first plurality of television transmitters and to selectively distribute different local content to different subsets of such television transmitters, and wherein each television transmitter is configured to transmit the common content and any local content received from the location-based service router over its at least one designated over-the-air broadcast television channel.

2. A cellular television broadcasting system according to claim 1, wherein at least one television transmitter is configured to multiplex the common content and the local content into a single transport stream of a digital television signal transmitted by the television transmitter.

3. A cellular television broadcasting system according to claim 2, wherein each television transmitter is further configured to transmit mapping information including channel and subchannel information associated with multiplexed content.

4. A cellular television broadcasting system according to claim 1, wherein the common content includes digital television programming required by an FCC license to be broadcast within a coverage area of at least one of the television transmitters.

5. A cellular television broadcasting system according to claim 1, wherein at least one television transmitter is further configured to transmit a beacon signal including channel availability information.

6. A cellular television broadcasting system according to claim 5, wherein the channel availability information includes at least one of:
information regarding television channels that are in-use;
information regarding television channels that must be avoided;
information regarding television channels that are available for use by other transmitters; and
information regarding return channels for user-to-system communications.

7. A cellular television broadcasting system according to claim 5, wherein the channel availability information is based on at least one of:
topology information;
third party whitespace information; and
reception measurements.

8. A cellular television broadcasting system according to claim 1, further comprising at least one content source in communication with the location-based service router.

9. A cellular television broadcasting system according to claim 8, wherein the at least one content source comprises at least one of:
a content server configured to store content;
a production server configured to automatically generate content based on information obtained from at least one third party information source;
a content creation web server configured to automatically generate content based on user-specified content and distribution information;
a premium content server configured to provide content relating to premium content services;
a unified call connector server configured to provide content relating to messaging and other communication services;
an interactive server configured to provide content relating to interactive Internet access services;
a media exchange system configured to store user content for use by other users; and
a peer-to-peer content distribution network.

10. A cellular television broadcasting system according to claim 8, further comprising at least one receiver configured to receive user-to-system communications over a designated return channel for at least one of:
an interactive service associated at least one content source; and
collecting usage information.

11. A cellular television broadcasting system according to claim 1, wherein the location-based service router is further configured to add advertisements to at least one of the common content and the local content.

12. A cellular television broadcasting system according to claim 1, further comprising at least one second transmission station including a second location-based service router and a second plurality of television transmitters, wherein the first and second location-based service routers are in communication with at least one common content source.

13. A cellular television broadcasting system according to claim 12, wherein the at least one common content source includes a peer-to-peer content distribution network configured to distribute content to a plurality of peer nodes including the first and second location-based service routers.

14. A cellular television broadcasting system according to claim 13, wherein the peer-to-peer content distribution network logically operates as a hierarchy of nodes including at least one set of nodes, the nodes in the set managed by a hierarchically higher managing node that manages peer-to-peer communications for the nodes, such that one or more nodes are managed by a managing node and one or more managing nodes may be managed by a hierarchically higher managing node.

15. A cellular television broadcasting system according to claim 14, wherein the nodes in the peer-to-peer network communicate using aliases so as to be independent of underlying node addresses.

16. A cellular television broadcasting system according to claim 14, wherein each managing node is configured to permit peer-to-peer communication between the nodes it manages and to permit peer-to-peer communication between a node it manages and a node managed by another managing node.

17. A cellular television broadcasting system according to claim 16, wherein peer-to-peer communication between the nodes managed by the managing node is permitted free of charge and wherein peer-to-peer communication between a node managed by the managing node and a node managed by another managing node is permitted for a charge.

18. A cellular television broadcasting system according to claim 14, wherein each managing node is configured to perform security and administrative functions for the nodes it manages.

19. A cellular television broadcasting system according to claim 13, further comprising at least one user device in communication with the peer-to-peer network, the user device configured to operate as a peer node in the peer-to-peer network.

20. A cellular television broadcasting system according to claim 13, wherein a portion of content is stored in multiple locations within the peer-to-peer network for at least one of backup and load sharing.

21. A cellular television broadcasting system according to claim 12, wherein the at least one common content source includes a media exchange system configured to store user content for use by other users, wherein at least one quantum of user content includes a tag for at least one of identifying the user content as being available and tracking usage of the content.

22. A cellular television broadcasting system comprising:
a location-based server for distributing content; and
a plurality of transmitters, each transmitter in communication with the location-based server for transmitting content over at least one over-the-air broadcast television channel, wherein the content includes at least one free-to-air television broadcast distributed by the location-based server to each of the plurality of television transmitters and local content selectively distributed by the location-based server to a subset of at least one but less than all of the transmitters.

23. A peer-to-peer network for distributing content to a plurality of peer nodes in a cellular television broadcasting system, the peer-to-peer network comprising:
at least one set of nodes, the nodes in the set managed by a hierarchically higher managing node that manages peer-to-peer communications for the nodes, such that one or more nodes are managed by a managing node and one or more managing nodes may be managed by a hierarchically higher managing node.

24. A peer-to-peer network according to claim 23, wherein the nodes in the peer-to-peer network communicate using aliases so as to be independent of underlying node addresses.

25. A peer-to-peer network according to claim 23, wherein each managing node is configured to permit peer-to-peer communication between the nodes it manages and to permit peer-to-peer communication between a node it manages and a node managed by another managing node.

26. A peer-to-peer network according to claim 25, wherein peer-to-peer communication between the nodes managed by the managing node is permitted free of charge and wherein peer-to-peer communication between a node managed by the managing node and a node managed by another managing node is permitted for a charge.

27. A peer-to-peer network according to claim 23, wherein each managing node is configured to perform security and administrative functions for the nodes it manages.

28. A peer-to-peer network according to claim 23, further comprising at least one user device in communication with the peer-to-peer network, the user device configured to operate as a peer node in the peer-to-peer network.

29. A peer-to-peer network according to claim 28, wherein the user device is a broadband router configured to operate as a peer node in the peer-to-peer network.

30. A peer-to-peer network according to claim 23, wherein a portion of content is stored in multiple locations within the peer-to-peer network for at least one of backup and load sharing.
